(19) United States
(12) Patent Application Publication
(10) Pub. No.: US 2023/0370279 A1
(43) Pub. Date: Nov. 16, 2023

(54) TERMINAL DEVICE, DATA MANAGEMENT DEVICE, MANAGEMENT SYSTEM, PROCESSING METHOD, AND NON-TRANSITORY COMPUTER-READABLE MEDIUM STORING A PROGRAM

(71) Applicant: NEC Corporation, Minato-ku, Tokyo (JP)

(72) Inventor: Kentaro Ito, Tokyo (JP)

(73) Assignee: NEC Corporation, Minato-ku, Tokyo (JP)

(21) Appl. No.: 18/022,360

(22) PCT Filed: Aug. 27, 2020
(86) PCT No.: PCT/JP2020/032356

§ 371 Date: Feb. 21, 2023

(51) Int. Cl. H04L 9/32; H04L 9/00

(52) U.S. Cl. CPC H04L 9/3247; H04L 9/50; H04L 9/3239

(57) ABSTRACT

There are provided a terminal device, a data management device, a management system, a processing method, a data management method, a management method, and a non-transitory computer-readable medium storing a program that are capable of improving reliability. A terminal device is connected to a network together with other terminal devices, retains a blockchain formed by linking data generated by the respective terminal devices or a hash value of the data as blocks together with the other terminal devices, and adds, when a new terminal device is to be added to the network, new data generated by the new terminal device or a hash value of the new data to the blockchain together with the other terminal devices.

### TECHNICAL FIELD

The present invention relates to a terminal device, a data management device, a management system, a processing method, a data management method, a management method, and a non-transitory computer-readable medium storing a program.

### BACKGROUND ART

Patent Literatures 1 and 2 each disclose an electronic illumination system that uses a trail registered in a blockchain to ensure data reliability. In addition, there is a widely known technique of distributing and storing data to multiple third parties to achieve storage that is difficult to be falsified.

### CITATION LIST

### Patent Literature

Patent Literature 1: Japanese Patent No. 6340107
Patent Literature 2: Japanese Patent No. 6480528

### SUMMARY OF INVENTION

### Technical Problem

The management systems disclosed in Patent Literatures 1 and 2 can ensure the authenticity of devices by managing traceability information at the time of manufacture with a blockchain, but do not take into account the perspective of preventing falsification of logs and settings values during operation. Even if there is a mistake in the settings, it is difficult to notice abnormal behavior when the white list or other information is falsified illegally as if it were the correct settings. In addition, when the operation logs are falsified, it is difficult to take action properly even if information is transmitted to an unauthorized connection point.

The systems disclosed in Patent Literatures 1 and 2 can achieve storage that is difficult to be falsified by distributing and storing data to multiple third parties, but are not suitable for collecting data from devices scattered in multiple locations, such as Internet of Things (IoT) systems, because the systems require data to be transmitted via specific access points, and the like.

Furthermore, in the systems disclosed in Patent Literatures 1 and 2, storing operational logs and setting value data of edge devices for each tenant and each customer increases management costs and the risk of operational stoppage in the event of disasters or major failures. In addition, there is a risk of data loss in the event that a service provider is unable to continue its business.

When an IoT system is provided as a service, various actors are involved in the operational process, which increases the risk of someone arbitrarily falsifying data.

A purpose of the present disclosure is to solve such a problem and to provide a terminal device, a data management device, a management system, a processing method, a data management method, a management method, and a non-transitory computer-readable medium storing a program that are capable of improving reliability.

### Solution to Problem

A terminal device according to the present disclosure is connected to a network together with other terminal devices, retains a blockchain formed by linking data generated by each terminal device or a hash value of the data as blocks together with the other terminal devices, and adds, when a new terminal device is to be added to the network, new data generated by the new terminal device or a hash value of the new data to the blockchain together with the other terminal devices.

### Advantageous Effects of Invention

According to the present disclosure, it is possible to provide a terminal device, a data management device, a management system, a processing method, a data management method, a management method, and a non-transitory computer-readable medium storing a program that are capable of improving reliability.

### BRIEF DESCRIPTION OF DRAWINGS

FIG. 1 is a block diagram showing examples of a plurality of terminal devices and a network in a management system according to an example embodiment;

FIG. 2 is a diagram showing an example of a blockchain in the management system according to the example embodiment;

FIG. 3 is a configuration diagram showing an example of a terminal device in the management system according to the example embodiment;

FIG. 4 is a flowchart diagram showing an example of a management method for adding a new terminal device in the management system according to the example embodiment;

FIG. 5 is a block diagram showing an example of a state where a new terminal device is added in the management system according to the example embodiment;

FIG. 6 is a flowchart diagram showing an example of a processing method of a terminal device when a new terminal device is to be added in the management system according to the example embodiment;

FIG. 7 is a flowchart diagram showing an example of a method for causing each terminal device to retain a blockchain in the management system according to the example embodiment;

FIG. 8 is a flowchart diagram showing an example of a management method for detecting falsification in the management system according to the example embodiment;

FIG. 9 is a flowchart diagram showing an example of a processing method of a terminal device that detects falsification in the management system according to the example embodiment;

FIG. 10 is a block diagram showing examples of a plurality of terminal devices, a data management device, and a network in a management system according to a first example embodiment;

FIG. 11 is a block diagram showing an example of a terminal device in the management system according to the first example embodiment;

FIG. 12 is a block diagram showing an example of a new terminal device to be added in the management system according to the first example embodiment;

FIG. 13 is a block diagram showing an example of a data management device in the management system according to the first example embodiment;

FIG. 14 is a sequence diagram showing an example of a management method for adding a new terminal device in the management system according to the first example embodiment;

FIG. 15 is a block diagram showing an example of a state where a new terminal device is added in the management system according to the first example embodiment;

FIG. 16 is a block diagram showing an example of the data management device to which electronically-signed data generated by a new terminal device has been added in the management system according to the first example embodiment;

FIG. 17 is a flowchart diagram showing an example of a processing method of a new terminal device to be added in the management system according to the first example embodiment;

FIG. 18 is a flowchart diagram showing an example of a processing method of a network-side terminal device in the management system according to the first example embodiment;

FIG. 19 is a flowchart diagram showing an example of a data management method of the data management device in the management system according to the first example embodiment;

FIG. 20 is a block diagram showing examples of a terminal device that detects falsification and a network in the management system according to the first example embodiment;

FIG. 21 is a sequence diagram showing an example of a management method for detecting falsification in the management system according to the first example embodiment;

FIG. 22 is a flowchart diagram showing an example of a processing method of a terminal device that detects falsification in the management system according to the example embodiment;

FIG. 23 is a flowchart diagram showing an example of a method for detecting falsification in the management system according to the first example embodiment;

FIG. 24 is a block diagram showing examples of a terminal device that restores data, other terminal devices, a data management device, a server device, and a network in the management system according to the first example embodiment;

FIG. 25 is a block diagram showing an example of the data management device in the management system according to the first example embodiment;

FIG. 26 is a sequence diagram showing an example of a management method for restoring data in the management system according to the first example embodiment;

FIG. 27 is a flowchart diagram showing an example of a processing method of a terminal device that restores data in the management system according to the example embodiment;

FIG. 28 is a flowchart diagram showing an example of a processing method for resorting data in the management system according to the first example embodiment;

FIG. 29 is a flowchart diagram showing an example of a data management method of a data management device that restores data in the management system according to the first example embodiment;

FIG. 30 is a block diagram showing examples of a plurality of terminal devices, a data management device, and a network in a management system according to a second example embodiment;

FIG. 31 is a block diagram showing an example of a terminal device in the management system according to the second example embodiment; and

FIG. 32 is a block diagram showing an example of a data management device in the management system according to the second example embodiment.

### EXAMPLE EMBODIMENT

The following description and the drawings are appropriately omitted or simplified to clarify the explanation. In the drawings, the same elements are denoted by the same reference signs, and duplicated descriptions are omitted as necessary.

### Outline of Example Embodiment

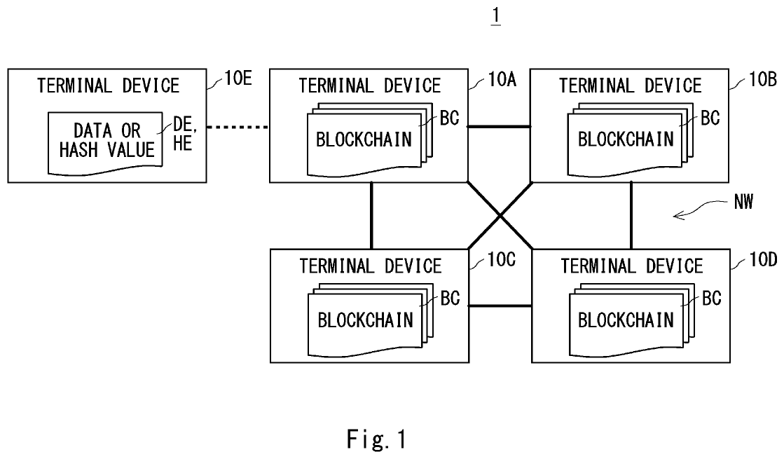

The following is an outline of a management system according to an example embodiment. FIG. 1 is a block diagram showing examples of a plurality of terminal devices and a network in the management system according to the example embodiment. As shown in FIG. 1, a management system 1 includes a plurality of terminal devices 10A to 10D and a network NW connected with the terminal devices 10A to 10D. For example, the terminal device 10A is connected to the network NW together with the other terminal devices 10B to 10D. Each of the terminal devices 10A to 10D is connected to the network NW in a state of being communicable by a wireless or wired communication line. Each of the terminal devices 10A to 10D may be connected in a state of being communicable at all times or may be connected when transmitting or receiving information.

Each of the terminal devices 10A to 10D may be connected to the network NW by a peer to peer method. Each of the terminal devices 10A to 10D retains a blockchain BC formed by linking data generated by each of the terminal devices 10A to 10D or a hash value of the data as blocks. Each of the terminal devices 10A to 10D retains, for example, the identical blockchain BC. When a new terminal device 10E is to be added to the network NW, each of the terminal devices 10A to 10D adds new data DE generated by the new terminal device 10E or a hash value HE of the new data DE to the blockchain BC.

Of the terminal devices 10A to 10D, one terminal device, for example, the terminal device 10A is focused on. Then, the terminal device 10A retains the blockchain BC together with the other terminal devices 10B to 10D. When a new terminal device 10E is to be added to the network NW, the terminal device 10A adds the new data DE generated by the new terminal device 10E or the hash value HE of the new data DE to the blockchain BC together with the other terminal devices 10B to 10D. In the following, <Blockchain> is described, followed by <Outline of Terminal Device>. Thereafter, <Outline of Operation> of the management system 1 and the terminal devices 10A to 10D is described.

### <Blockchain>

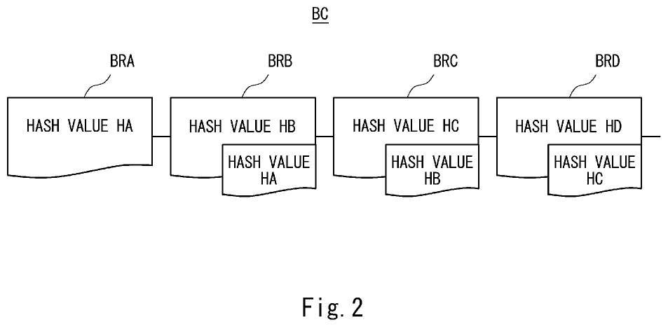

FIG. 2 shows an example of the blockchain BC in the management system 1 according to the example embodiment. As shown in FIG. 2, the blockchain BC is formed by linking data generated by each of the terminal devices 10A to 10D or hash values HA to HD of the data as blocks BRA to BRD. The data includes log data, such as operation logs acquired by each of the terminal devices 10A to 10D, and setting data related to setting values of allowed list (white lists). Therefore, each of the terminal devices 10A to 10D manages the hash values HA to HD of the log data and setting data on the public blockchain BC.

Note that FIG. 2 shows that the blocks BRA to BRD constituting the blockchain BC contain the hash values HA to HD, but the blocks BRA to BRD may contain data, not limited to the hash values HA to HD. Therefore, an object to be managed with the blockchain BC is not limited to the hash values HA to HD but may also be data itself. In addition, FIG. 2 shows only four blocks BRA to BRD, but the number of blocks may be three or less or five or more.

For example, the terminal devices 10A to 10D are edge devices. In that case, the blockchain BC is formed with the edge devices connected to a service as nodes. The blockchain BC retains a cache value of data of each node. Specifically, in the blockchain BC, the block BRA, the block BRB, the block BRC, and the block BRD are linked in this order, for example. The block BRA contains the hash value HA of the data generated by the terminal device 10A. The block BRB contains a hash value HB of the data generated by the terminal device 10B. The block BRC contains the hash value HC of the data generated by the terminal device 10C. The block BRD contains the hash value HD of the data generated by the terminal device 10D. In this case, the block BRB contains the hash value HA as the cache value. The block BRC contains the hash value HB as the cache value. The block BRD contains the hash value HC as the cache value.

The blockchain BC may have already been constructed. The hash values of the edge device data may be retained on the constructed blockchain BC, or the edge device data itself may be retained on the constructed blockchain BC.

### <Outline of Terminal Device>

Next, a terminal device 10 is described. Any one of the terminal devices 10A to 10E is referred to as the terminal device 10. In addition, one or more of the terminal devices 10A to 10E can be collectively referred to as the terminal device 10. When any of the terminal devices 10A to 10E is specified, the terminal device is indicated with one of the reference signs 10A to 10E. The terminal device 10 may be constituted by hardware including a microcomputer constituted by, for example, a central processing unit (CPU), a read only memory (ROM), a random access memory (RAM), and an interface unit (I/F), and the like. The CPU performs processing, such as calculation processing, duplication processing, verification processing, control processing, and the like. The ROM stores programs to be executed by the CPU, such as a processing program, a control program, and the like. The RAM stores various types of data, such as data, hash values, and the like. The interface unit (I/F) performs input/output of signals, data, and the like to/from the outside. The CPU, ROM, RAM, and interface unit are interconnected via a data bus or the like.

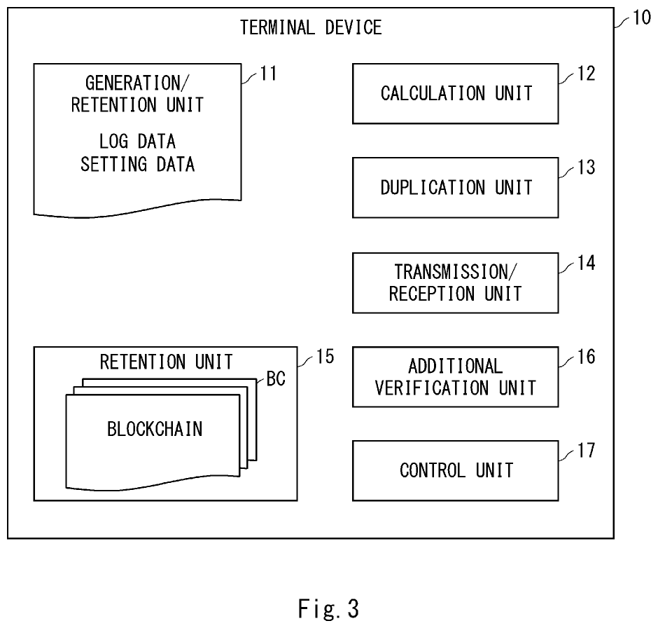

FIG. 3 is a configuration diagram showing an example of the terminal device 10 in the management system 1 according to the example embodiment. As shown in FIG. 3, the terminal device 10 includes a generation/retention unit 11, a calculation unit 12, a duplication unit 13, a transmission/reception unit 14, a retention unit 15, an additional verification unit 16, and a control unit 17. The generation/retention unit 11, the calculation unit 12, the duplication unit 13, the transmission/reception unit 14, the retention unit 15, the additional verification unit 16, and the control unit 17 have functions as a generation/retention means of data, a calculation means of a hash value, a duplication means of data and a hash value, and a transmission/reception means of data and a hash value, a retention means of a blockchain, an additional verification means of a hash value, and a control means of the terminal device 10, respectively.

The generation/retention unit 11 generates data and retains the generated data as retention data. For example, the generation/retention unit 11 generates and retains log data, such as operation logs and the like. The generation/retention unit 11 also retains setting data related to setting values, such as white lists and the like.

The calculation unit 12 calculates a hash value of the generated data. The duplication unit 13 duplicates at least one of the data and the hash value.

The transmission/reception unit 14 transmits at least one of the duplicated data and hash value to the network NW as transmission data and a transmission hash value. The transmission/reception unit 14 also receives at least one of the data and hash values from another terminal device 10 as reception data and a reception hash value.

The retention unit 15 retains the blockchain BC formed by linking the data generated by each of the terminal devices 10A to 10D or the hash values HA to HD of the data as blocks.

The additional verification unit 16 adds the received reception data or reception hash value to the blockchain BC. In addition, when a new terminal device 10 is to be added to the network NW, the additional verification unit 16 adds new data DE generated by the new terminal device 10 or a hash value HE of the new data DE to the blockchain BC.

Furthermore, the additional verification unit 16 detects falsification of the retention data by comparing the retention data retained in the generation/retention unit 11 or the hash value of the retention data with the transmission data or the transmission hash value contained in the blockchain BC retained by the other terminal device 10. Specifically, the additional verification unit 16 of the terminal device 10A detects falsification of the retention data retained by the terminal device 10A by comparing the retention data retained in the generation/retention unit 11 of the terminal device 10A or the hash value of the retention data with the transmission data or the transmission hash value contained in the blockchain BC retained by the terminal device 10B. Here, the transmission data and the transmission hash value are those transmitted by the terminal device 10A to the terminal device 10B.

The control unit 17 disconnects from a server device that provides a service on the network NW when the additional verification unit 16 detects falsification. Then, the control unit 17 invalidates the retention data when falsification is detected.

### <Outline of Operation>

Next, as operations of the management system 1 according to the present example embodiment, addition of a terminal device and detection of falsification are described. Details of each operation will be described in a first example embodiment. First, <Outline of Addition of Terminal Device> is described.

### <Outline of Addition of Terminal Device>

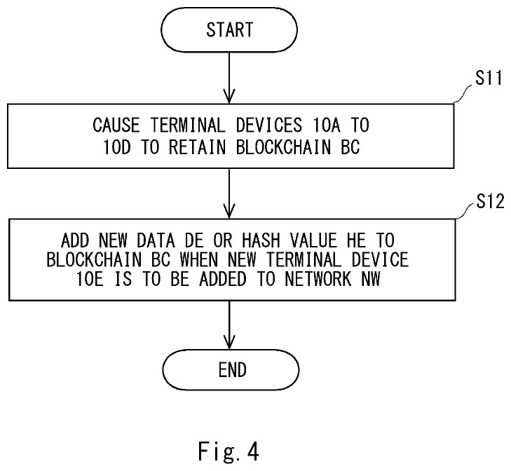

First, a management method of the management system 1 in the outline of addition of a terminal device is described. FIG. 4 is a flowchart diagram showing an example of the management method for adding a new terminal device 10 in the management system 1.

As shown in step S11 in FIG. 4, each of the terminal devices 10A to 10D is caused to retain the blockchain BC. Specifically, for example, each of the terminal devices 10A to 10D is caused to retain the blockchain BC formed by linking, as blocks, data generated by each of the terminal devices 10A to 10D on the network NW connected with the terminal devices 10A to 10D or the hash values of HA to HD of the data.

Next, as shown in step S12, when the new terminal device 10E is to be added to the network NW, new data DE generated by the new terminal device 10E or a hash value HE of the new data DE is added to the blockchain BC.

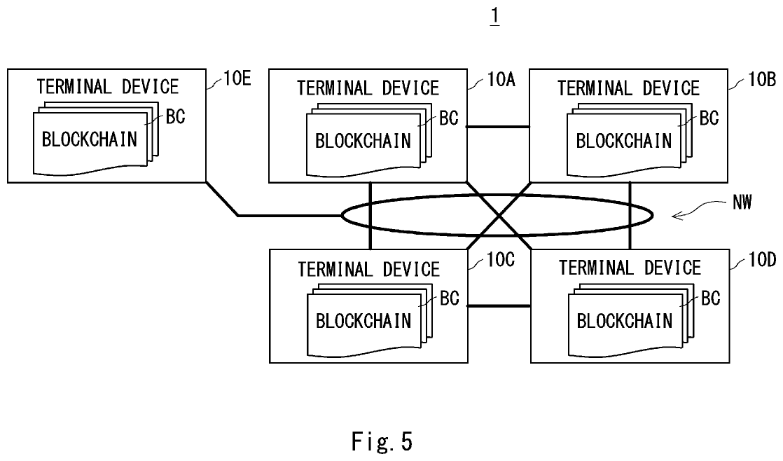

FIG. 5 is a block diagram showing an example of a state where the new terminal device 10E is added in the management system 1 according to the example embodiment. In the drawing, the peer-to-peer network NW is shown as an ellipse. As shown in FIG. 5, the new terminal device 10E is added to the network NW connected with the terminal devices 10A to 10D. The new data DE or the hash value HE of the new data DE is added to the blockchain BC retained by each of the terminal devices 10A to 10D. Then, the new terminal device 10E retains the blockchain BC retained by each of the terminal devices 10A to 10D.

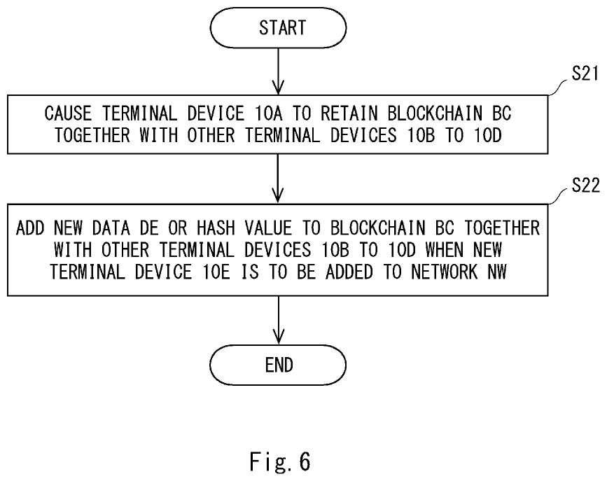

Next, a processing method of the terminal device 10A in the outline of addition of a terminal device is described. FIG. 6 is a flowchart showing an example of the processing method of the terminal device 10A when the new terminal device 10E is to be added in the management system 1 according to the example embodiment. Of the terminal devices 10A to 10D, the terminal device 10A is focused on and described. The same description applies to the terminal devices 10B to 10D.

As shown in step S21 in FIG. 6, the terminal device 10A is caused to retain the blockchain BC together with the other terminal devices 10B to 10D. Specifically, the terminal device 10A is caused, together with the other terminal devices 10B to 10D, to retain the blockchain BC in the network NW connected together with the other terminal devices 10B to 10D.

Next, as shown in step S22, when the new terminal device 10E is to be added to the network, the terminal device 10A is caused, together with the other terminal devices 10B to 10D, to add the new data DE generated by the new terminal device 10E or the hash value HE of the new data DE to the blockchain BC in the network NW.

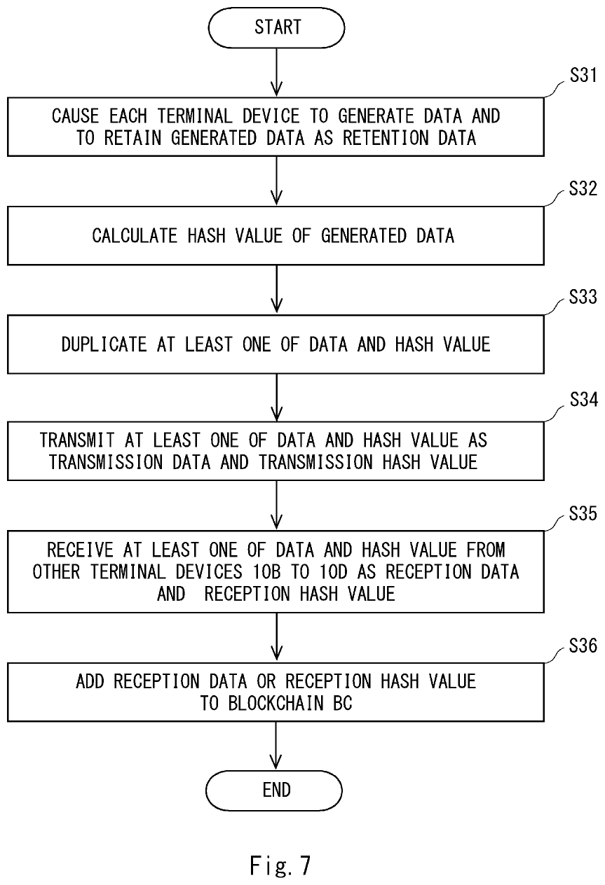

Step S11 in FIG. 4 and step S21 in FIG. 6 may be performed as shown in FIG. 7. FIG. 7 is a flowchart showing an example of a method for causing each of the terminal devices 10A to 10D to retain the blockchain BC in the management system 1 according to the example embodiment.

As shown in step S31 in FIG. 7, when each of the terminal devices 10A to 10D is caused to retain the blockchain BC, each of the terminal devices 10A to 10D is caused to generate data and retain the generated data as retention data.

Next, as shown in step S32, the calculation unit 12 is caused to calculate the hash value of the generated data. Then, as shown in step S33, the duplication unit 13 is caused to duplicate at least one of the data and the hash value.

Next, as shown in step S34, the transmission/reception unit 14 is caused to transmit at least one of the duplicated data and the duplicated hash value as the transmission data and the transmission hash value to the network NW. In addition, as shown in step S35, the transmission/reception unit 14 is caused to receive at least one of the data and the hash value from the other terminal devices 10B to 10D as the reception data and the reception hash value.

Next, as shown in step S36, the additional verification unit 16 is caused to add the reception data or reception hash value to the blockchain BC. In this manner, the retention unit 15 of each of the terminal devices 10A to 10D is caused to retain the blockchain BC.

### <Outline of Detection of Falsification>

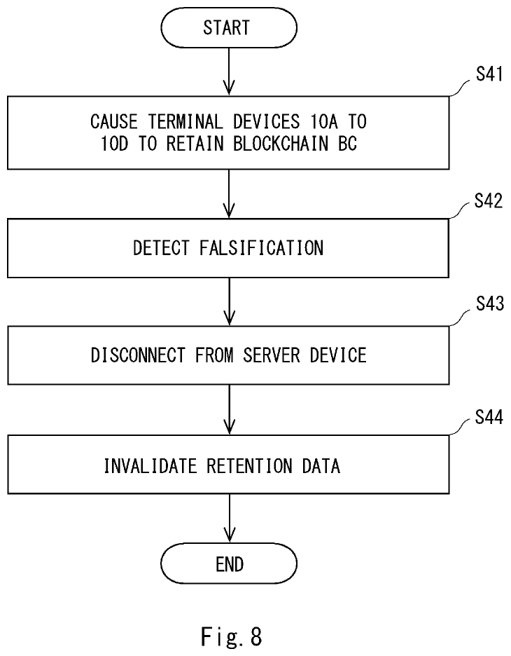

Next, <Outline of Detection of Falsification> is described as an operation of the management system 1. First, a management method of the management system 1 in the outline of detection of falsification is described. FIG. 8 is a flowchart diagram showing an example of the management method for detecting falsification in the management system 1 according to the example embodiment.

As shown in step S41 in FIG. 8, each of the terminal devices 10A to 10D is caused to retain the blockchain BC. Step S41 is similar to step S11 in FIG. 4.

Next, as shown in step S42, for example, the terminal device 10A is caused to detect falsification of the retention data. Specifically, the additional verification unit 16 of the terminal device 10A is caused to detect falsification of the retention data by comparing the retention data retained by the terminal device 10A or the hash value of the retention data with the transmission data or the transmission hash value contained in the blockchain BC retained by the other terminal devices 10B to 10D. The transmission data and the transmission hash value are those transmitted by the terminal device 10A to the other terminal devices 10B to 10D.

In order to express the terminal devices 10A to 10D in a generalized manner, when, for example, the terminal device 10A is referred to as a first terminal device and the terminal device 10B is referred to as a second terminal device, the terminal devices 10A to 10D include at least the first terminal device and the second terminal device. In this case, the first terminal device detects falsification of the retention data by comparing the retention data or the hash value of the retention data with the transmission data or the transmission hash value transmitted by the first terminal device and contained in the blockchain BC retained by the second terminal device.

Next, as shown in step S43, the terminal device 10A is caused to disconnect from the server device. Specifically, when the additional verification unit 16 of the terminal device 10A detects falsification, the control unit 17 of terminal device 10A is caused to disconnect from the server device that provides a service on the network NW. The server device provides, for example, an operation management service, a security service, or the like.

Next, as shown in step S44, the terminal device 10A is caused to invalidate the retention data. Specifically, when the additional verification unit 16 of the terminal device 10A detects falsification, the control unit 17 of the terminal device 10A invalidates the retention data retained in the generation/retention unit 11. For example, the control unit 17 of the terminal device 10A marks the falsified retention data with a flag or the like in order for the data not to be used in subsequent processing.

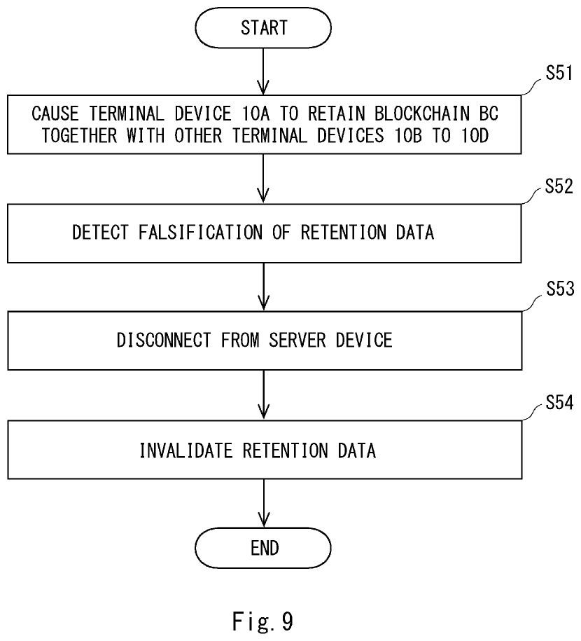

Next, a processing method of the terminal device 10A in detection of falsification is described. FIG. 9 is a flowchart diagram showing an example of the processing method of a terminal device that detects falsification in the management system 1 according to the example embodiment.

As shown in step S51 in FIG. 9, the terminal device 10A is caused to retain the blockchain BC together with the other terminal devices 10B to 10D. Step S51 is similar to step S21 in FIG. 6.

Next, as shown in step S52, the terminal device 10A is caused to detect falsification of the retention data. Specifically, the additional verification unit 16 of the terminal device 10A is caused to detect falsification by comparing the retention data retained by the terminal device 10A or the hash value of the retention data with the transmission data or the transmission hash value contained in the blockchain BC retained by the other terminal devices 10B to 10D.

Next, as shown in step S53, the terminal device 10A is caused to disconnect from the server device. Specifically, when the additional verification unit 16 of the terminal device 10A detects falsification, the control unit 17 of the terminal device 10A is caused to disconnect from the server device that provides the service on the network NW.

Next, as shown in step S54, the terminal device 10A is caused to invalidate the retention data. Specifically, when the additional verification unit 16 of the terminal device 10A detects falsification, the control unit 17 of the terminal device 10A invalidates the retention data retained in the generation/retention unit 11.

Next, the effects of the present example embodiment are described. Since each of the terminal devices 10A to 10D in the management system 1 retains the blockchain BC, it is possible to improve the reliability of the management system 1. In addition, when the new terminal device 10E is to be added, each of the terminal devices 10A to 10D adds the new data DE or the hash value HE of the new data DE to the blockchain BC. Accordingly, it is possible to improve the reliability of the new data DE. Furthermore, since whether the retention data has been falsified is detected at predetermined intervals, it is possible to improve the reliability of the retention data.

### First Example Embodiment

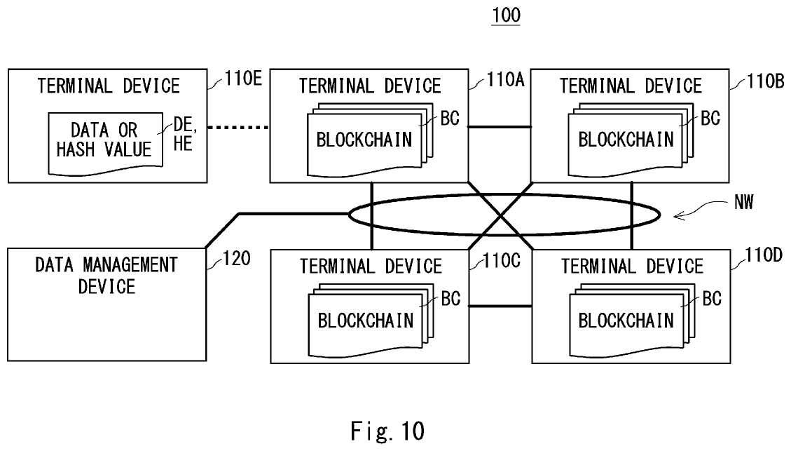

Next, a management system according to a first example embodiment is described. The management system according to the present example embodiment further includes a data management device. FIG. 10 is a block diagram showing examples of a plurality of terminal devices, a data management device, and a network in the management system according to the first example embodiment. As shown in FIG. 10, a management system 100 includes a plurality of terminal devices 110A to 110D, a data management device 120, and a network NW.

In the management system 100, the terminal devices 110A to 110D and the data management device 120 are connected to the network NW. For example, the terminal devices 110A to 110D and the data management device 120 are connected to the network NW by a peer to peer method. Thus, each of the terminal devices 110A to 110D is connected to the data management device 120. In the drawing, the peer-to-peer network NW is shown as an ellipse. A new terminal device 110E is to be added to the network NW.

In the following, configurations of <Terminal Device> and <Data Management Device> are described, and <I. Addition of Terminal Device>, <II. Detection of Falsification>, and <III. Restoration of Data> are detailedly described as operations of the management system 100.

### <Terminal Device>

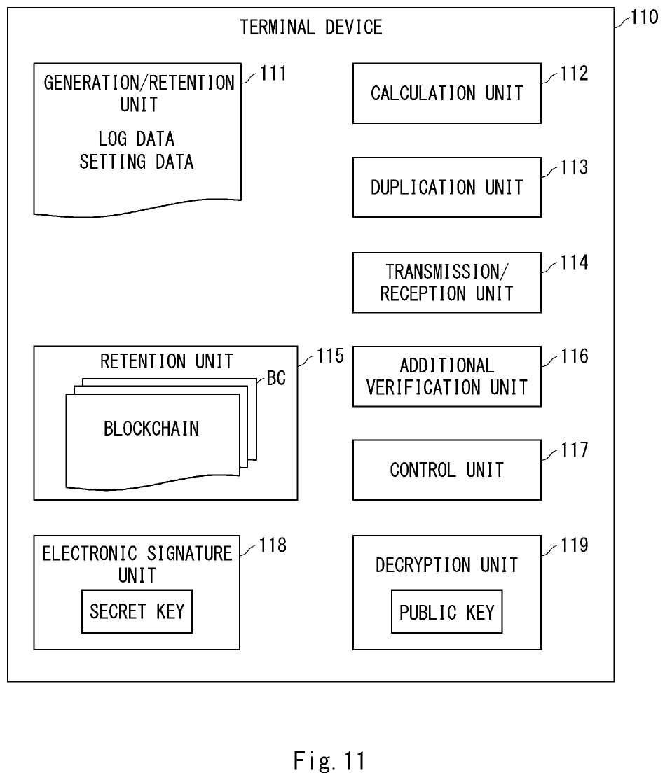

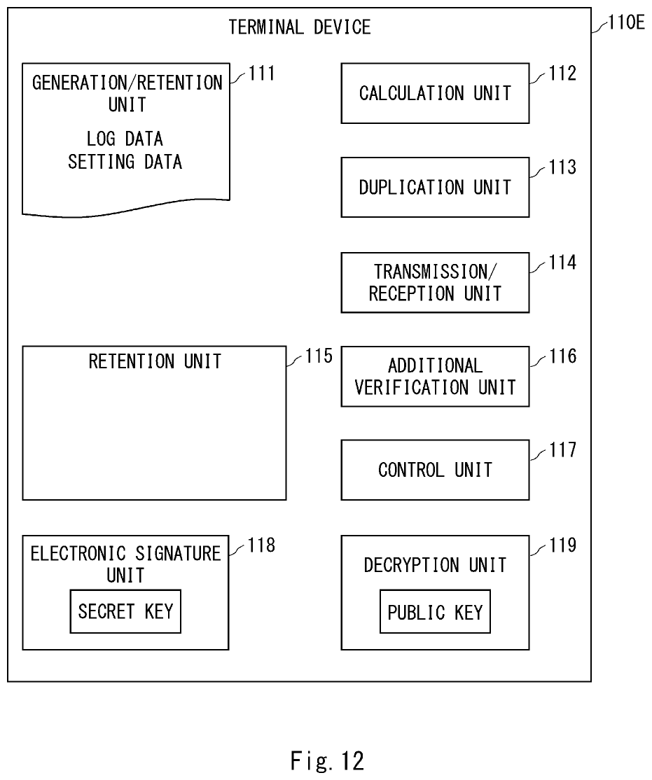

FIG. 11 is a block diagram showing an example of a terminal device 110 in the management system 100 according to the first example embodiment. FIG. 12 is a block diagram showing an example of a new terminal device 110E to be added in the management system 100 according to the first example embodiment.

As shown in FIG. 11, the terminal device 110 includes a generation/retention unit 111, a calculation unit 112, a duplication unit 113, a transmission/reception unit 114, a retention unit 115, an additional verification unit 116, and a control unit 117, similarly to the terminal device 10. The function of each component of the terminal device 110 is similar to that in the terminal device 10. As in the case of the terminal device 10, any of the terminal devices 110A to 110E can be referred to as the terminal device 110. In addition, one or more of the terminal devices 110A to 110E are collectively referred to as the terminal device 110. When any of the terminal devices 110A to 110E is specified, the terminal device is indicated with one of the reference signs 110A to 110E. The terminal device 110 may have a hardware configuration similar to that of the terminal device 10.

The terminal device 110 further includes an electronic signature unit 118 and a decryption unit 119. The electronic signature unit 118 and the decryption unit 119 have functions as a generation means for electronically-signed data and a decryption means for an electronic signature, respectively.

The electronic signature unit 118 generates electronically-signed data by adding, to the data generated by the generation/retention unit 111, an electronic signature formed using a secret key unique to each terminal device 110. Here, the electronic signature is, for example, an encrypted hash value of the data generated by the generation/retention unit 111, using the secret key unique to each terminal device 110.

The decryption unit 119 decrypts the electronic signature using a public key. Here, the electronic signature decrypted using the public key is, for example, the hash value of the data. The transmission/reception unit 114 transmits the electronically-signed data generated by the electronic signature unit 118 to the data management device 120 and receives the electronically-signed data from the data management device 120.

As shown in FIG. 12, the new terminal device 110E does not retain the blockchain BC in the retention unit 115. The configuration of the new terminal device 110E other than this is similar to the configuration of the terminal device 110.

### <Data Management Device>

The data management device 120 is connected to the network NW together with the terminal devices 110. Accordingly, the data management device 120 is connected to each terminal device 110 that retains the blockchain BC. The data management device 120 is, for example, a server that manages the operation of the management system 100. The data management device 120 may be constituted by hardware including a microcomputer constituted by, for example, a central processing unit (CPU), a read only memory (ROM), a random access memory (RAM), and an interface unit (I/F), and the like. The CPU performs processing, such as calculation processing, duplication processing, verification processing, control processing, and the like. The ROM stores programs to be executed by the CPU, such as a processing program, a control program, and the like. The RAM stores various types of data, such as data, hash values, and the like. The interface unit (I/F) performs input/output of signals, data, and the like to/from the outside. The CPU, ROM, RAM, and interface unit are interconnected via a data bus or the like.

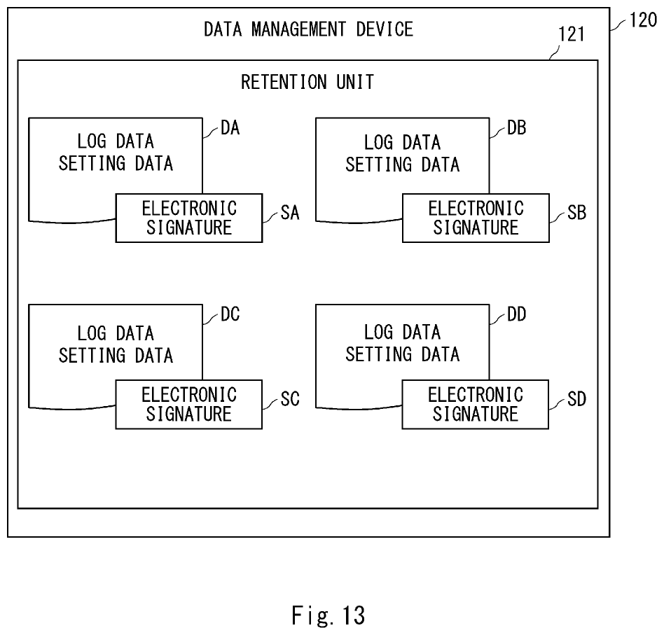

FIG. 13 is a block diagram showing an example of the management system 100 according to the first example embodiment. As shown in FIG. 13, the data management device 120 includes a retention unit 121. The retention unit 121 has a function as a retention means of electronically-signed data. The data management device 120 retains electronically-signed data generated by adding electronic signatures SA to SD formed by using secret keys unique to the respective terminal devices 110A to 110D to data DA to data DD generated by the respective terminal devices 110A to 110D. Specifically, the retention unit 121 of the data management device 120 manages the data DA to data DD generated by the generation/retention units 111 of the respective terminal devices 110A to 110D, such as log data, setting data, and the like, with the electronic signatures added. The electronic signatures SA to SD are added to the data DA to data DD using the secret keys unique to the respective terminal devices 110A to 110D.

When the new terminal device 110E is to be added to the network NW and when new data DE generated by the new terminal device 110E or a hash value HE of the new data DE is to be added to the blockchain BC retained by each of the terminal devices 110A to 110D, electronically-signed data DE generated by the new terminal device 110E is to be added to the data management device 120.

### <I. Addition of Terminal Device>

Next, <I. Addition of Terminal Device> is described as an operation of the management system 100 including the data management device 120. In terms of the blockchain BC being formed with the edge devices connected to a service as nodes, addition of the terminal device 110E is also addition of a node. First, <I-1. Management Method of Management System> in addition of a terminal device is described. Then, <I-2. Processing Method of New Terminal Device>, <I-3. Processing Method of Terminal Device>, and <I-4. Data Management Method of Data Management Device> are described.

### <I-1. Management Method of Management System>

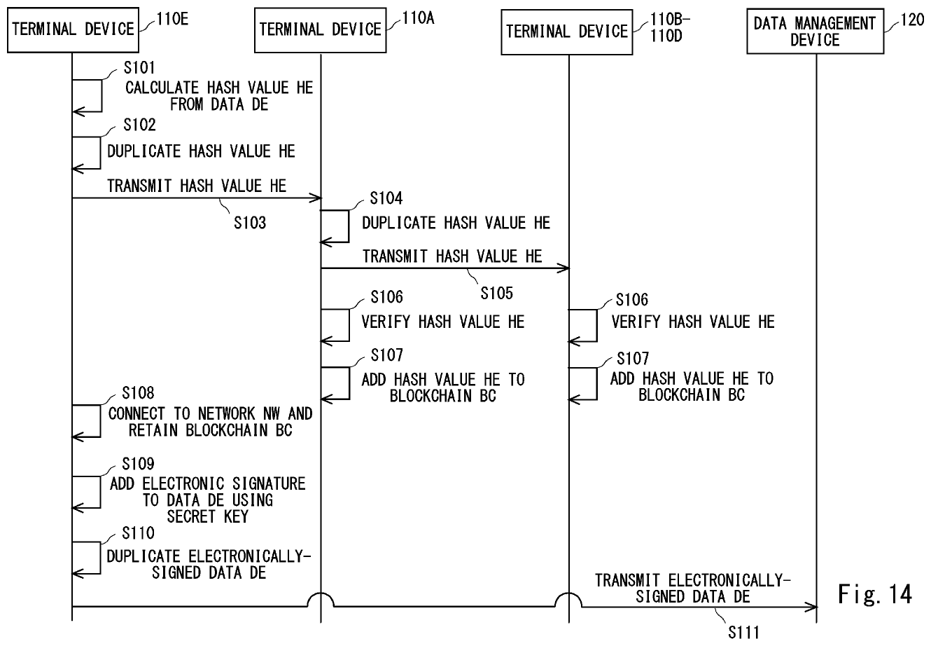

First, a management method of the management system 100 in addition of the terminal device 110E is described. FIG. 14 is a sequence diagram showing an example of the management method for adding the new terminal device 110E in the management system 100 according to the first example embodiment. As shown in step S101 in FIG. 14, the new terminal device 110E to be added to the management system 100 calculates the hash value HE from the data DE. Specifically, the calculation unit 112 of the terminal device 110E calculates the hash value HE from the data DE generated by the generation/retention unit 111.

Next, as shown in step S102, the terminal device 110E duplicates the hash value HE. Specifically, the duplication unit 113 of the terminal device 110E duplicates the hash value HE calculated by the calculation unit 112. When the blocks of the blockchain BC are composed of data, the duplication unit 113 of the terminal device 110E duplicates the data DE. In the following description for <I. Addition of Terminal Device>, <II. Detection of Falsification>, and <III. Restoration of Data>, the hash values HA to HE may be appropriately replaced with the data DA to data DE, respectively.

Next, as shown in step S103, the terminal device 110E transmits the hash value HE to the terminal device 110A. Specifically, the transmission/reception unit 114 of the terminal device 110E transmits the hash value HE to the transmission/reception unit 114 of the terminal device 110A.

Next, as shown in step S104, the terminal device 110A having received the hash value HE duplicates the hash value HE. Specifically, the duplication unit 113 of the terminal device 110A duplicates the hash value HE received by the transmission/reception unit 114.

Next, as shown in step S105, the terminal device 110A transmits the hash value HE to each of the terminal devices 110B to 110D. Specifically, the transmission/reception unit 114 of the terminal device 110A transmits the duplicated hash value HE to the transmission/reception unit 114 of each of the terminal devices 110B to 110D.

Next, as shown in step S106, each of the terminal devices 110A to 110D verifies the hash value HE. Specifically, the additional verification unit 116 of each of the terminal devices 110A to 110D verifies whether the hash value HE has a format as a hash value.

Next, as shown in step S107, each of the terminal devices 110A to 110D adds the hash value HE to the blockchain BC. Specifically, the additional verification unit of each of the terminal devices 110A to 110D 116 adds the new hash value HE to the blockchain BC retained in the retention unit 115.

Next, as shown in step S108, the new terminal device 110E is connected to the network NW. Then, the retention unit 115 of the new terminal device 110E retains the blockchain BC.

Next, as shown in step S109, the terminal device 110E adds an electronic signature to the data DE using a secret key. Specifically, the electronic signature unit 118 of the terminal device 110E adds, to the data DE generated by the generation/retention unit 11, an electronic signature formed using the secret key unique to the terminal device 110E. As a result, the electronic signature unit 118 generates the electronically-signed data DE.

Next, as shown in step S110, the duplication unit 113 of the terminal device 110E duplicates the electronically-signed data DE generated by the electronic signature unit 118.

Next, as shown in step S111, the transmission/reception unit 114 of the terminal device 110E transmits the electronically-signed data DE to the data management device 120. The data management device 120 receives the electronically-signed data DE and stores it in the retention unit 121.

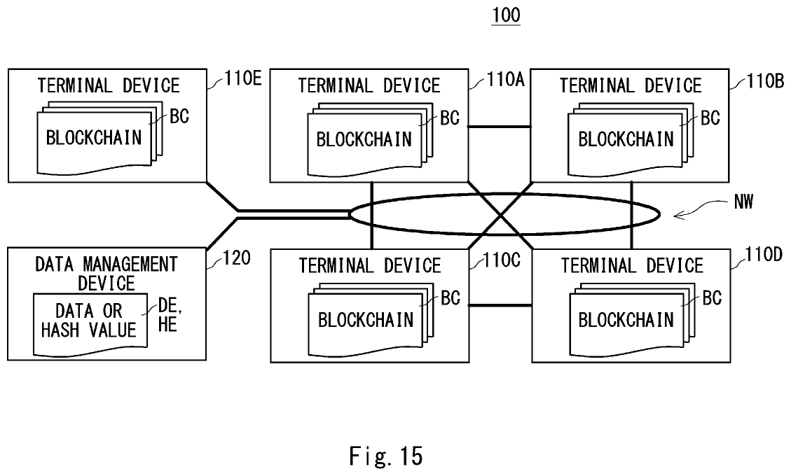

FIG. 15 is a block diagram showing an example of a state where the new terminal device 110E is added in the management system 100 according to the first example embodiment. As shown in FIG. 15, the management system 100 adds the new terminal device 110E to the network NW. Accordingly, the added terminal device 110E retains the blockchain BC similarly to the other terminal devices 110A to 110D.

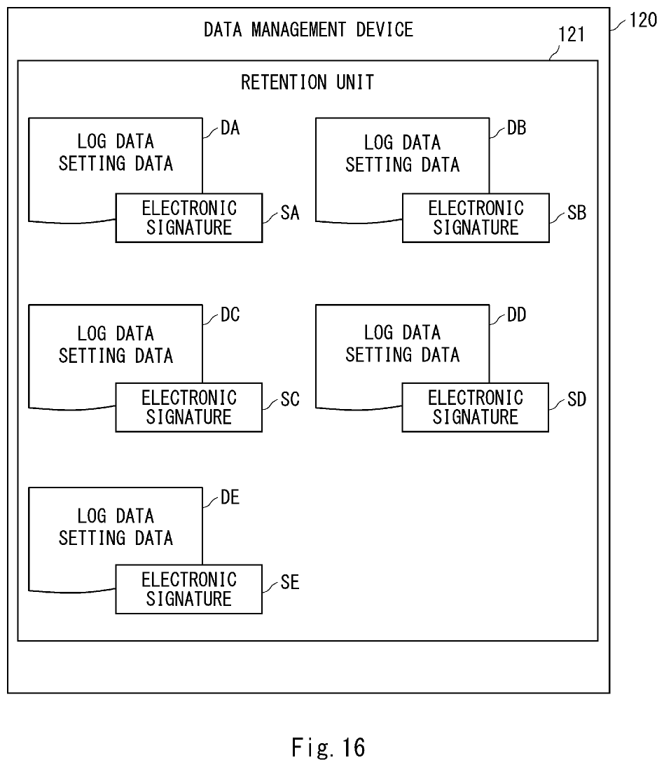

FIG. 16 is a block diagram showing an example of the data management device 120 to which the electronically-signed data DE generated by the new terminal device 110E is added in the management system 100 according to the first example embodiment. As shown in FIG. 16, the data management device 120 retains the electronically-signed data DE received from new terminal device 110E in the retention unit 121. To the electronically-signed data DE, an electronic signature SE formed using the secret key unique to the new terminal device 110E has been added.

### <I-2. Processing Method of New Terminal Device>

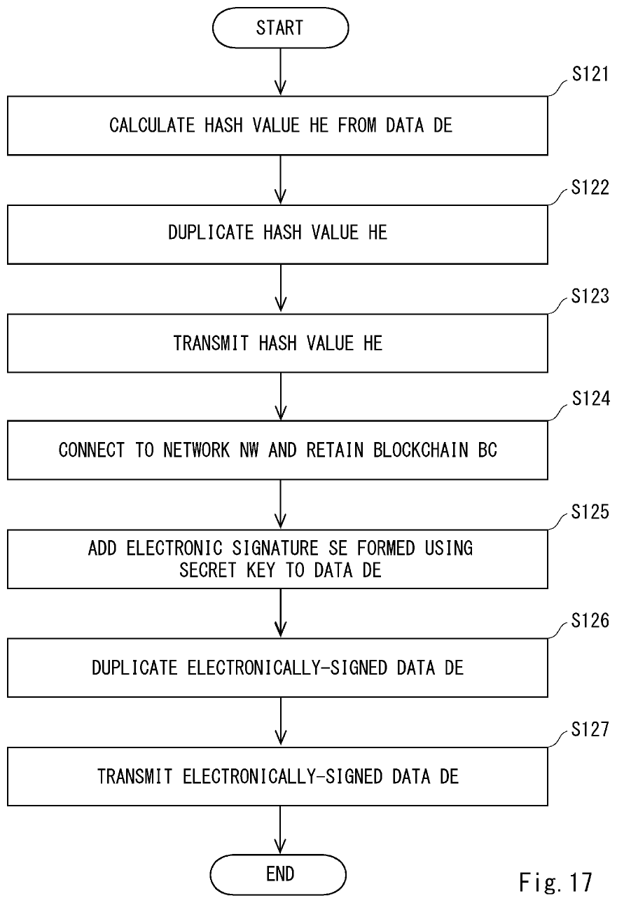

Next, a processing method of a new terminal device in addition of a terminal device is described. FIG. 17 is a flowchart diagram showing an example of the processing method of the new terminal device 110E to be added in the management system 100 according to the first example embodiment. As shown in step S121 in FIG. 17, the calculation unit 112 of the new terminal device 110E to be added to the management system 100 calculates the hash value HE from the data DE generated by the generation/retention unit 111.

Next, as shown in step S122, the duplication unit 13 of the terminal device 110E duplicates the hash value HE calculated by the calculation unit 112.

Next, as shown in step S123, the transmission/reception unit 114 of the terminal device 110E transmits the duplicated hash value HE to, for example, the transmission/reception unit 114 of the terminal device 110A.

Next, as shown in step S124, the terminal device 110E is connected to the network NW and retains the blockchain BC. Specifically, the additional verification unit 116 of each of the terminal devices 110A to 110D 116 verifies the hash value HE transmitted from the transmission/reception unit 114 of the terminal device 110E. For example, the additional verification unit 116 of each of the terminal devices 110A to 110D verifies whether the hash value HE has a format as a hash value. Thereafter, the additional verification unit 116 of each of the terminal devices 110A to 110D adds the new hash value HE to the blockchain BC retained in the retention unit 115. Accordingly, the new terminal device 110E is connected to the network NW. In addition, the retention unit 115 of the new terminal device 110E retains the blockchain BC.

Next, as shown in step S125, the electronic signature unit 118 of the terminal device 110E adds the electronic signature SE formed using the secret key unique to the terminal device 110E to the data DE. As a result, the electronic signature unit 118 generates the electronically-signed data DE.

Next, as shown in step S126, the duplication unit 113 of the terminal device 110E duplicates the electronically-signed data DE.

Next, as shown in step S127, the transmission/reception unit 114 of the terminal device 110E transmits the electronically-signed data DE to the data management device 120.

### <I-3. Processing Method of Terminal Device>

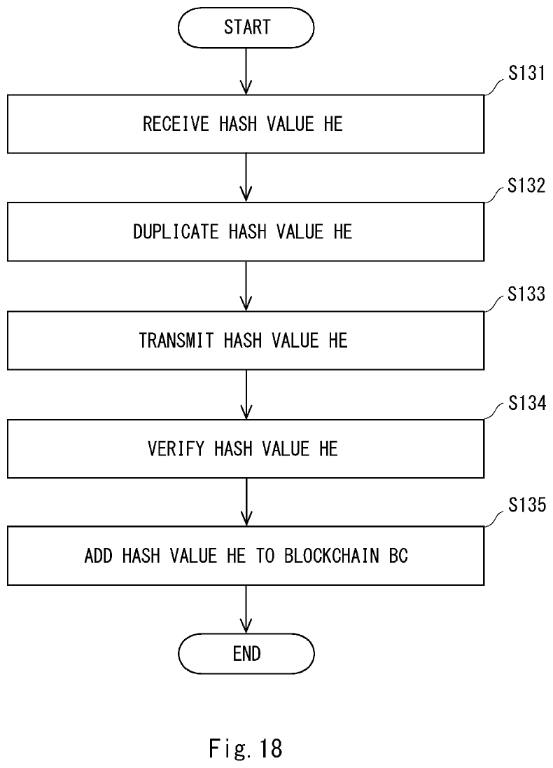

Next, a processing method of each of the terminal devices 110A to 110D on the network NW side that accepts the new terminal device 110E in addition of a terminal device is described. FIG. 18 is a flowchart diagram showing an example of the processing method of each of the terminal devices 110A to 110D on the network NW side in the management system 100 according to the first example embodiment.

As shown in step S131 in FIG. 18, for example, the transmission/reception unit 114 of the terminal device 110A receives the hash value HE from the new terminal device 110E. Next, as shown in step S132, the duplication unit 113 of the terminal device 110A having received the hash value HE duplicates the hash value HE received by the transmission/reception unit 114.

Next, as shown in step S133, the transmission/reception unit 114 of the terminal device 110A transmits the duplicated hash value HE to the transmission/reception unit 114 of each of the other terminal devices 110B to 110D.

Next, as shown in step S134, the additional verification unit 116 of each of the terminal devices 110A to 110D verifies whether the hash value HE has a format as a hash value.

Next, as shown in step S135, the additional verification unit 116 of each of the terminal devices 110A to 110D adds the new hash value HE to the blockchain BC retained by the retention unit 115.

In this manner, when the new terminal device 110E is to be added to the network NW, the terminal device 110A adds the new hash value HE of the data DE generated by the new terminal device 110E to the blockchain BC after the verification together with the other terminal devices 110B to 110D.

### <I-4. Data Management Method of Data Management Device>

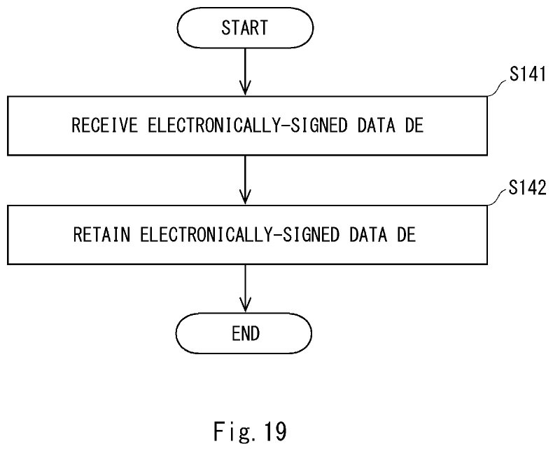

Next, a data management method of the data management device 120 when the new terminal device 10E is to be added is described. FIG. 19 is a flowchart diagram showing an example of the data management method of the data management device 120 in the management system 100 according to the first example embodiment.

As shown in step S141 in FIG. 19, the data management device 120 receives the electronically-signed data DE transmitted from the terminal device 110E. Then, as shown in step S142 and FIG. 16, the data management device 120 retains the electronically-signed data DE received from the terminal device 110E in the retention unit 121.

### <II. Detection of Falsification>

Next, detection of falsification is described as an operation of the management system 100. For example, it is assumed that a falsifying person, such as a hacker or the like, falsifies the retention data DA to retention data DD retained in the generation/retention units 111 of the terminal devices 110A to 110D. Therefore, for example, falsification is detected periodically or at a timing of referring to the retention data. First, <II-1. Management Method of Management System> in detection of falsification is described. Then, <II-2. Processing Method of Terminal Device> in detection of falsification is described.

### <II-1. Management Method of Management System>

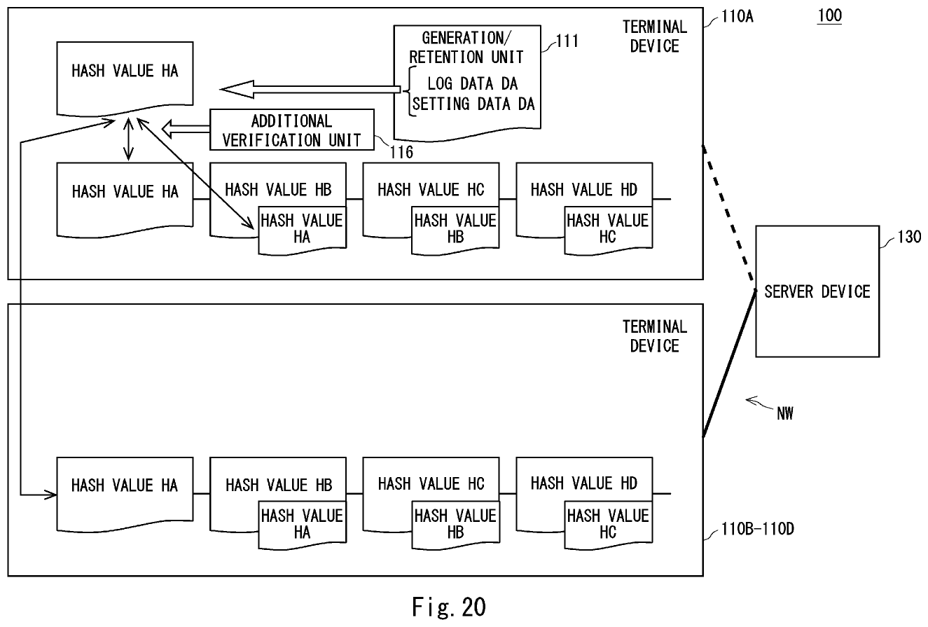

FIG. 20 is a block diagram showing examples of the terminal devices 110A to 110D that detect falsification and the network NW in the management system 100 according to the first example embodiment. As shown in FIG. 20, the management system 100 includes the terminal devices 110A to 110D, the network NW, and a server device 130 connected to the network NW. The server device 130 provides a service. The service is, for example, an operation management service, a security monitoring service, or the like. Note that each of the terminal devices 110A to 110D retains the blockchain BC.

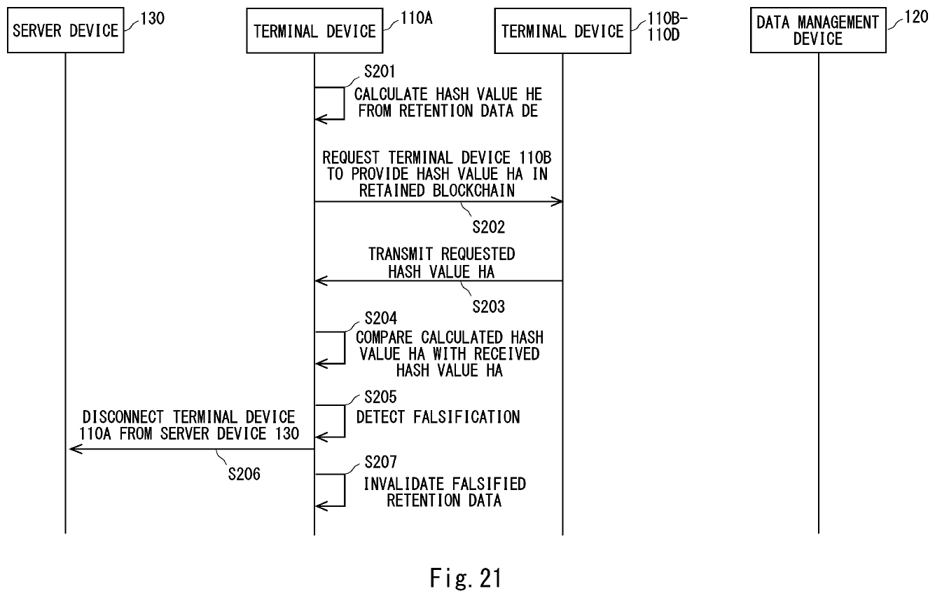

FIG. 21 is a sequence diagram showing an example of a management method for detecting falsification in the management system 100 according to the first example embodiment. As shown in step S201 in FIG. 21, the terminal device 110A that detects falsification among the terminal devices 110A to 110D causes the calculation unit 112 to calculate the hash value HA from the retained retention data DA.

Next, as shown in step S202, the control unit 117 of the terminal device 110A requests the terminal device 110B to provide the hash value HA contained in a black chain BC retained by the terminal device 110B. The hash value HA contained in the black chain BC retained by the terminal device 110B is, from the point of view of the terminal device 110A, the transmission hash value HA transmitted by the terminal device 110A. In response to this, as shown in step S203, the transmission/reception unit 114 of the terminal device 110B transmits the requested hash value HA to the terminal device 110A. Then, the transmission/reception unit 114 of the terminal device 110A receives the hash value HA transmitted from the terminal device 110B.

Next, as shown in step S204, the additional verification unit 116 of the terminal device 110A compares the hash value HA calculated from the retention data DA in the terminal device 110A with the hash value HA received from the terminal device 110B. As mentioned above, the hash value HA received from the terminal device 110B is the hash value HA contained in the blockchain BC retained by the terminal device 110B.

As shown in FIG. 20, the additional verification unit 116 of the terminal device 110A may compare the hash value HA calculated from the retention data DA with the hash value HA contained in the blockchain BC retained by the terminal device 110A. Alternatively, the additional verification unit 116 of the terminal device 110A may compare the hash value HA calculated from the retention data DA with the hash value HA contained as a cash value in a block of the hash value HB contained in the blockchain BC retained by the terminal device 110A.

Next, as shown in step S205 in FIG. 21, when the calculated hash value HA and the received hash value HA are different after the comparison, the additional verification unit 116 of the terminal device 110A detects falsification of the retention data DA retained in the generation/retention unit 111.

Next, as shown in step S206, the control unit 117 of the terminal device 110A disconnects from the server device 130 to separate the terminal device 110A from the network NW.

Next, as shown in step S207, the control unit 117 of the terminal device 110A invalidates the falsified retention data DA. For example, the control unit 117 of the terminal device 110A marks the falsified retention data DA with a flag or the like in order for the data not to be used in subsequent processing.

### <II-2. Processing Method of Terminal Device>

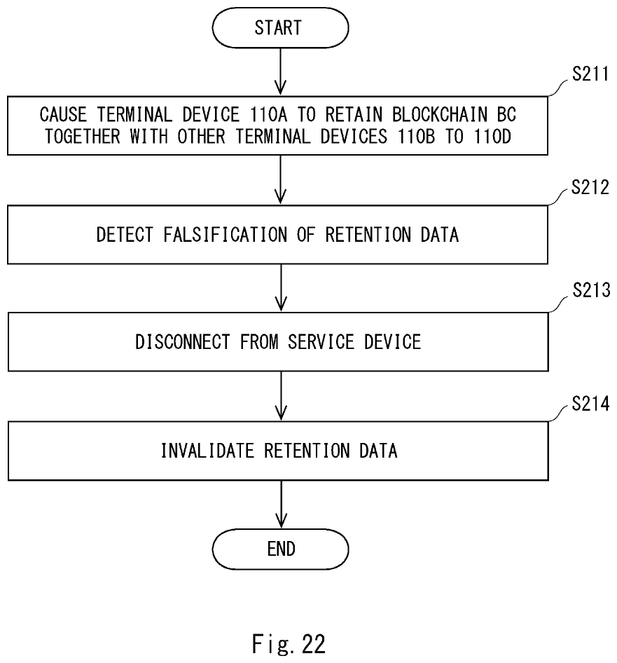

Next, a processing method of a terminal device in detection of falsification is described. FIG. 22 is a flowchart diagram showing an example of the processing method of a terminal device in detection of falsification in the management system 100 according to the example embodiment.

As shown in step S211 in FIG. 22, for example, the terminal device 110A is caused to retain the blockchain BC together with the other terminal devices 110B to 110D. Step S211 is similar to step S51 in FIG. 9.

Next, as shown in step S212, the terminal device 110A is caused to detect falsification of the retention data DA. Specifically, the additional verification unit 116 is caused to detect falsification of the retention data DA by comparing the retention data DA retained by the terminal device 110A or the hash value HA of the retention data DA with the transmission data DA or the transmission hash value HA contained in the blockchain BC retained by the other terminal devices 110B to 110D.

Next, as shown in step S213, when the additional verification unit 116 of the terminal device 110A detects falsification, the control unit 117 of the terminal device 110A is caused to disconnect from the server device 130 that provides the service on the network NW.

Next, as shown in step S214, when falsification is detected, the control unit 117 of the terminal device 110A invalidates the retention data DA retained in the generation/retention unit 111.

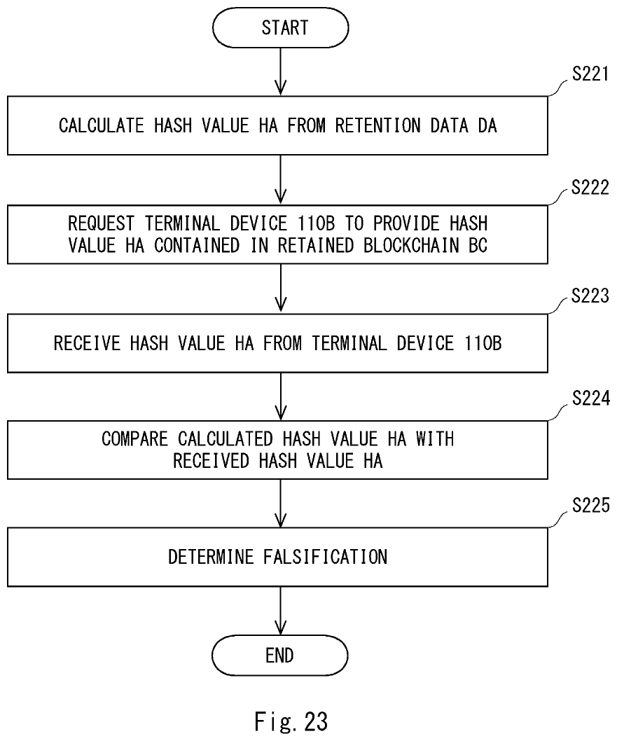

Step S212 is performed by the following method shown in FIG. 23. FIG. 23 is a flowchart diagram showing an example of a method for detecting falsification in the management system 100 according to the first example embodiment. As shown in step S221 in FIG. 23, the calculation unit 112 of the terminal device 110A calculates the hash value HA from the retention data DA retained in the generation/retention unit 111.

Next, as shown in step S222, the control unit 117 of the terminal device 110A requests the terminal device 110B to provide the hash value HA contained in the blockchain BC retained by the terminal device 110B.

Next, as shown in step S223, the transmission/reception unit 114 of the terminal device 110A receives the requested hash value HA from the terminal device 110B.

Next, as shown in step S224, the additional verification unit 116 of the terminal device 110A compares the hash value HA calculated from the retention data DA with the hash value HA received from the terminal device 110B.

Next, as shown in step S225, the additional verification unit 116 of the terminal device 110A determines falsification. Specifically, when the calculated hash value HA and the received hash value HA are different after the comparison, the additional verification unit 116 of the terminal device 110A detects falsification of the retention data DA retained in the generation/retention unit 111. In this manner, the terminal device 110A detects falsification of the retention data DA.

### <III. Restoration of Data>

Next, restoration of data is described as an operation of the management system 100 according to the first example embodiment. First, <III-1. Management Method of Management System> in restoration of data is described, followed by <III-2. Processing Method of Terminal Device> and <III-3. Data Management Method of Data management device.

### <III-1. Management Method of Management System>

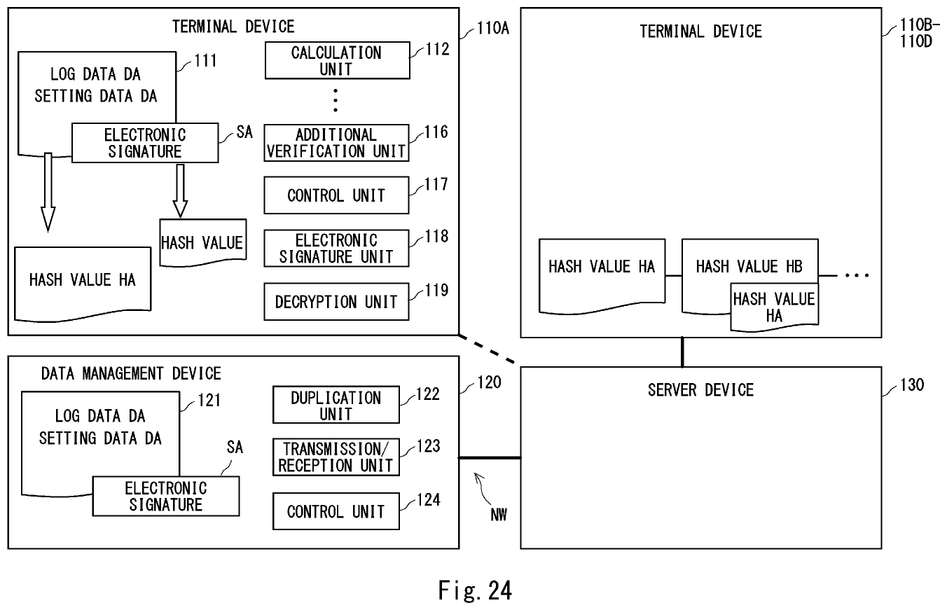

FIG. 24 is a block diagram showing examples of the terminal device 110A that restores data, the other terminal devices 110B to 110D, the data management device 120, the server device 130, and the network NW in the management system 100 according to the first example embodiment. As shown in FIG. 24, the management system 100 includes the terminal device 110A, the terminal devices 110B to 110D, the network NW, the data management device 120, and the server device 130. The terminal device 110A is disconnected from the server device 130 that provides the service on the network NW. In the drawing, the configurations of the terminal devices 110A to 110D and the data management device 120 are shown simplified as appropriate.

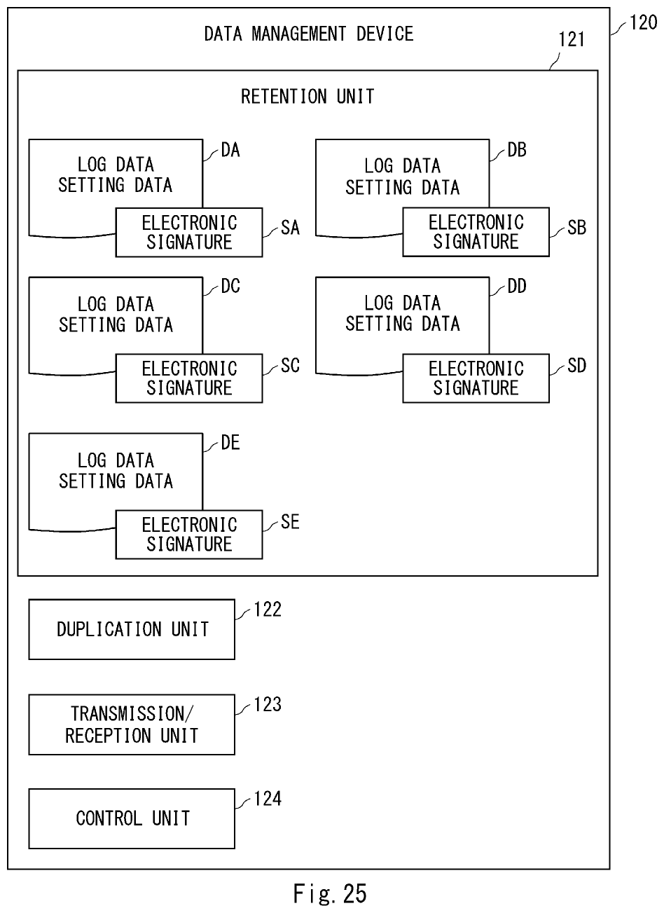

FIG. 25 is a block diagram showing an example of the data management device 120 in the management system 100 according to the first example embodiment. As shown in FIG. 25, the data management device 120 includes, in addition to the retention unit 121, a duplication unit 122, a transmission/reception unit 123, and a control unit 124. The duplication unit 122, the transmission/reception unit 123, and the control unit 124 have functions as a duplication means for duplicating electronically-signed data, a transmission/reception means for transmitting and receiving electronically-signed data, and a control means for controlling the data management device 120 (the retention unit 121, the duplication unit 122, and the transmission/reception unit 123), respectively.

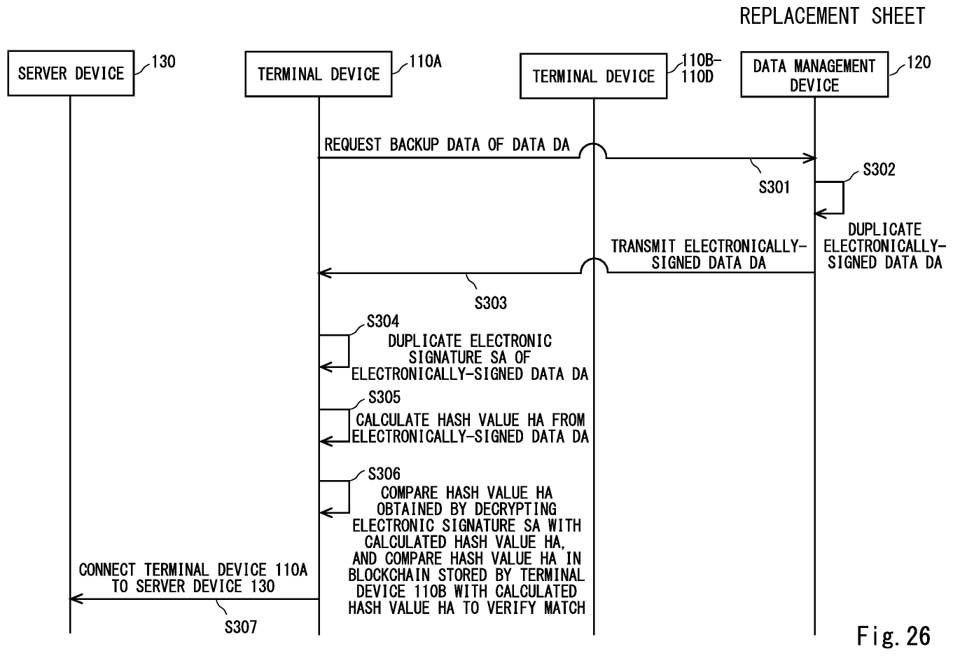

FIG. 26 is a sequence diagram showing an example of a management method for restoring data in the management system 100 according to the first example embodiment. As shown in step S301 in FIG. 26 and FIG. 24, the control unit 117 of the terminal device 110A requests the control unit 124 of the data management device 120 to provide electronically-signed data DA retained by the data management device 120.

Next, as shown in step S302, the duplication unit 122 of the data management device 120 duplicates the electronically-signed data DA retained by the data management device 120.

Next, as shown in step S303, the transmission/reception unit 123 of the data management device 120 transmits the duplicated electronically-signed data DA to the transmission/reception unit 114 of the terminal device 110A. In this manner, when the terminal device 110A that has been disconnected from the network NW is to be reconnected to the network NW, the data management device 120 transmits the retained electronically-signed data DA to the terminal device 110A.

Next, as shown in step S304, the decryption unit 119 of the terminal device 110A receives the electronically-signed data DA from the data management device 120. Then, the decryption unit 119 decrypts the electronic signature SA of the received electronically-signed data DA. The decrypted electronic signature SA is, for example, the hash value HA of the data DA.

Next, as shown in step S305, the calculation unit 112 of the terminal device 110A calculates the hash value HA of the electronically-signed data DA received from the data management device 120.

Next, as shown in step S306, the additional verification unit 116 of the terminal device 110A compares the hash value HA obtained by decrypting the electronic signature SA with the calculated hash value HA of the electronically-signed data DA to verify that the received electronically-signed data DA is that of the terminal device 110A. In addition, the additional verification unit 116 of the terminal device 110A compares the hash value HA contained in the blockchain BC retained by the terminal device 110B with the calculated hash value HA to verify the match. In this manner, the terminal device 110A according to the present example embodiment can ensure the authenticity of the electronically-signed data DA received from the data management device 120 by two steps with the hash value HA obtained from the electronic signature SA and the hash value HA contained in the blockchain BC retained by the terminal device 110B.

Next, as shown in step S307, the control unit 117 of the terminal device 110A connects the terminal device 110A to the server device 130.

In this manner, in the management system 100, when the terminal devices 110A to 110D include at least the first terminal device and the second terminal device, the decryption unit 119 of the first terminal device receives electronically-signed data from the data management device 120 and decrypts the electronic signature of the received electronically-signed data. The calculation unit 112 of the first terminal device calculates the hash value of the received electronically-signed data. The additional verification unit 116 of the first terminal device verifies the match between the received electronically-signed data or the calculated hash value and the transmission data or the transmission hash value transmitted by the first terminal device and contained in the blockchain BC retained by the second terminal device. When the additional verification unit 116 verifies the match, the control unit 17 of the first terminal device connects the first terminal device to the network NW.

### <III-2. Processing Method of Terminal Device>

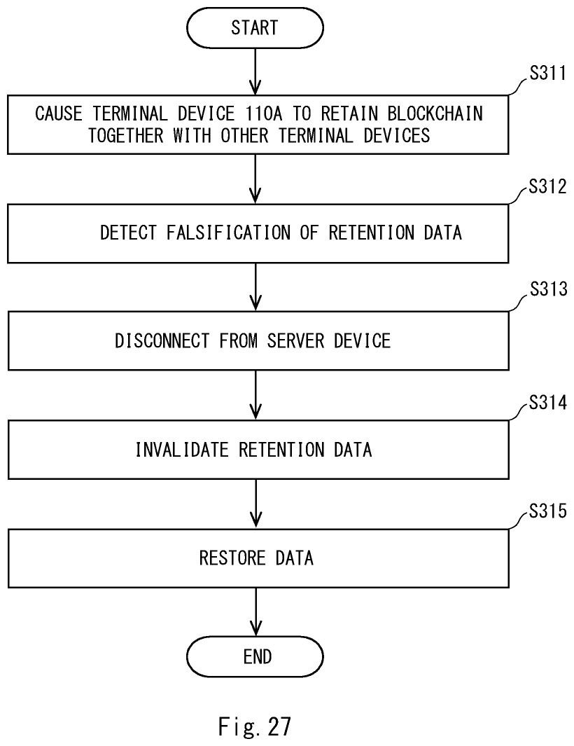

Next, a processing method of a terminal device in restoration of data is described. FIG. 27 is a flowchart diagram showing an example of the processing method of the terminal device 110A that restores data in the management system 100 according to the example embodiment.

As shown in FIG. 27, steps S311 to S314 are similar to steps S211 to S214 in FIG. 22. After invalidating the retention data, the terminal device 110A restores data as shown in step S315.

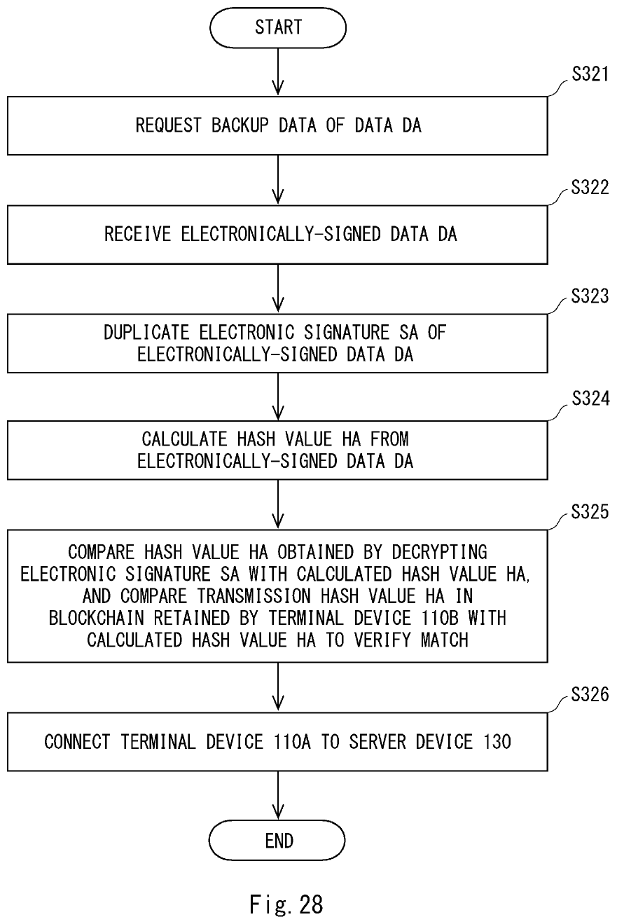

The restoration of data in step S315 in FIG. 27 is performed by, for example, the method shown in FIG. 28. FIG. 28 is a flowchart diagram showing an example of the processing method for restoring data in the management system 100 according to the first example embodiment. As shown in step S321 in FIG. 28, for example, the control unit 117 of the terminal device 110A request the control unit 124 of the data management device 120 to provide backup data of the electronically-signed data DA retained in the retention unit 121.

Next, as shown in step S322, the transmission/reception unit 114 of the terminal device 110A receives the electronically-signed data DA transmitted from the transmission/reception unit 123 of the data management device 120.

Next, as shown in step S323, the decryption unit 119 of the terminal device 110A receives the electronically-signed data DA from the data management device 120 and decrypts the electronic signature SA of the received electronically-signed data DA. By decrypting the electronic signature SA, the hash value HA of the data DA is obtained.

Next, as shown in step S324, the calculation unit 112 of the terminal device 110A calculates the hash value HA of the electronically-signed data DA received from the data management device 120.

Next, as shown in step S325, the additional verification unit 116 of the terminal device 110A compares the hash value HA obtained by decrypting the electronic signature SA with the calculated hash value HA to verify that the electronically-signed data DA has been generated by the terminal device 110A. In addition, the additional verification unit 116 of the terminal device 110A compares the transmission hash value HA contained in the blockchain BC retained by the terminal device 110B with the calculated hash value HA to verify the match.

Next, as shown in step S326, when the additional verification unit 116 verifies the match, the control unit 117 of the terminal device 110A connects the terminal device 110A to the network NW to connect the terminal device 110A to the server device 130. In this manner, the terminal device 110A restores the data DA.

<III-3. Data Management Method of Data Management Device>

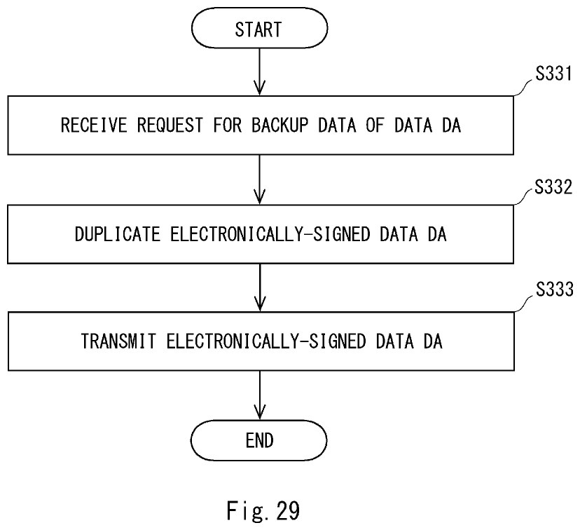

Next, a data management method of the data management device in restoration of data is described. FIG. 29 is a flowchart diagram showing an example of the data management method of the data management device 120 that restores data in the management system 100 according to the first example embodiment.

As shown in step S331 in FIG. 29, the control unit 124 of the data management device 120 receives a request for backup data of the data DA from the terminal device 110A that has been disconnected from the network NW.

Next, as shown in step S332, the duplication unit 122 of the data management device 120 duplicates the electronically-signed data DA retained in the retention unit 121.

Next, as shown in step S333, the transmission/reception unit 123 of the data management device 120 transmits the duplicated electronically-signed data DA to the terminal device 110A. In this manner, the data management device 120 transmits the duplicated electronically-signed data DA to the terminal device 110A. Accordingly, the terminal device 110A can restore the data.

Next, the effects of the management system 100 according to the present example embodiment are described. Since the management system 100 according to the present example embodiment causes each of the terminal devices 110A to 110D to retain the blockchain BC, it is possible to improve the reliability of the management system 100 and the retention data through the addition of the new terminal device 110E, the detection of falsification, and the restoration of data.

In addition, the management system 100 includes the data management device 120 that retains the electronically-signed data DE of each of the terminal devices 110A to 110D. Thus, when the terminal device 110 that have been disconnected from the management system 100 is to be reconnected, the data can be restored.

In addition, when the new terminal device 110E is to be added to the management system 100, the new data DE can be added to the data management device 120.

When falsification is detected, each of the terminal devices 110A to 110D is disconnected from the server device 130. In addition, the data retained by the disconnected terminal device 110 is invalidated. Accordingly, it is possible to improve the reliability of the management system 100 and the retention data.

In addition, since the management system 100 uses a public blockchain BC, it is possible to prevent falsification accessible by actors and arbitrary falsification.

For example, the management system 100 can provide a security service infrastructure that integrally operates and manages securely manufactured edge devices. Accordingly, the management system 100 can construct a system including edge IoT devices, servers, and the like. Thus, by achieving lifecycle management throughout the entire process from device production to distribution, installation, operation, maintenance, and disposal, it is possible to ensure the security and reliability of products and data handled therein.

Furthermore, the management system 100 can achieve detection of falsification by registering and managing hash values of setting values, such as operational logs and white lists, on the blockchain BC. In addition, the management system 100 can automatically control the terminal device 110, such as an edge device, to be separated from the management system 100 and to reconnect the separated terminal device 110 to the management system 100.

As described above, the management system 100 can prevent falsification of logs and setting values during operation, and even if a white list or other information is falsified illegally due to a mistake in the settings or the like, the management system 100 can detect the falsification. If falsification is detected, the management system 100 can disconnect the terminal device 110 and take appropriate actions.

The management system 100 according to the present example embodiment may not retain operation logs, setting value data, and the like of the terminal device 110 for each tenant or each customer. Thus, the management system 100 can reduce management costs and the risk of operational stoppage in the event of disasters or major failures. In addition, if a service provider is unable to continue its business, it is possible to reduce a risk of data loss. Other configurations and effects are included in the description of the above example embodiment.

### Second Example Embodiment

Next, a management system according to a second example embodiment is described. The management system 100 according to the first example embodiment described above is a P2P network type. In contrast, the management system according to the present example embodiment is a client-to-server type.

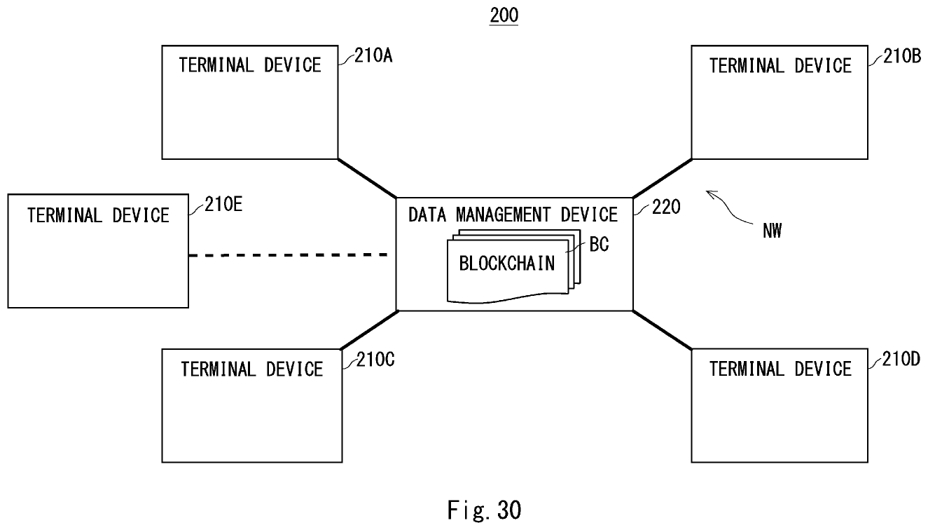

FIG. 30 is a block diagram showing examples of a plurality of terminal devices, a data management device, and a network in the management system according to the second example embodiment. As shown in FIG. 30, a management system 200 includes a plurality of terminal devices 210A to 210D, a data management device 220, and a network NW. The terminal devices 210A to 210D are connected to the network NW. The data management device 220 is also connected to the network NW. The terminal devices 210A to 210D are connected to the data management device 220 via the network NW.

In the present example embodiment, the management system 200 is a client-to-server type, and the terminal devices 210A to 210D are connected to the data management device 220. Note that the management system 200 may be further includes a server device connected to the network NW.

In the management system 200 according to the present example embodiment, the data management device 220 retains a blockchain BC formed by linking data generated by each of the terminal devices 210A to 210D or a hash value of the data as blocks. In addition, when a new terminal device 210E is to be added to the network NW, the data management device 220 adds new data generated by the new terminal device 210E or a hash value of the new data to the blockchain BC.

In the above-described management system 100 and the management system 200 according to the present example embodiment, the management system includes a plurality of devices and the network NW connected with the devices. At least one of the devices retains the blockchain BC formed by linking data generated by two or more of the devices or a hash value of the data as blocks. In the management system 100, each of the terminal devices 110A to 110D retains the blockchain BC. In the management system 200, the data management device 220 retains the blockchain BC. The configurations of <Terminal Device> and <Data management Device> are described below.

### <Terminal Device>

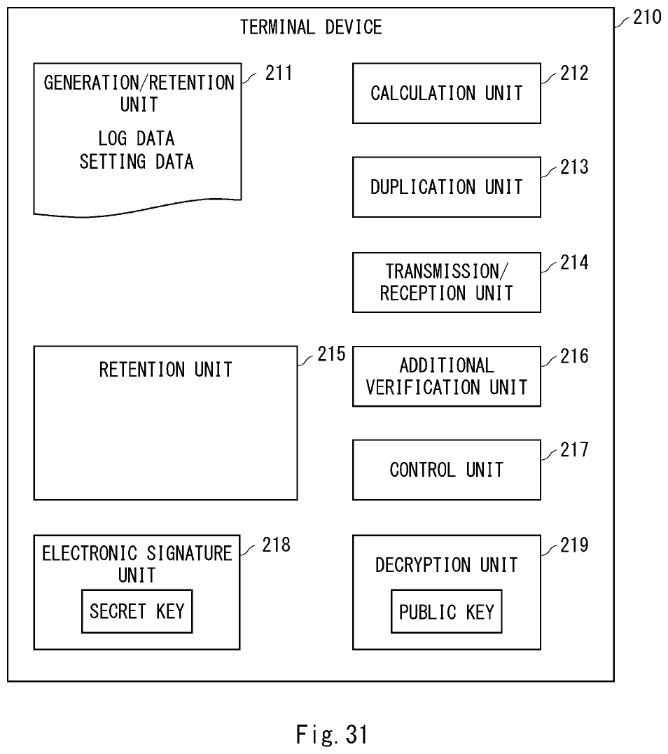

First, a configuration of each of the terminal devices 210A to 210D is described. FIG. 31 is a block diagram showing an example of the terminal devices 210 in the management system 200 according to the second example embodiment.

As shown in FIG. 31, the terminal device 210 may include, similar to the terminal device 110, a generation/retention unit 211, a calculation unit 212, a duplication unit 213, a transmission/reception unit 214, a retention unit 215, an additional verification unit 216, a control unit 217, an electronic signature unit 218, and a decryption unit 219 or may not include some components. The function of each component of the terminal device 210 is similar to that of the terminal device 110. As in the case of the terminal device 110, any of the terminal devices 210A to 210E, or one or more of the terminal devices 210A to 210E are collectively referred to as the terminal device 210. When any of the terminal devices 210A to 210E is specified, the terminal device is indicated with one of the reference signs 210A to 210E. The terminal device 210 may have a hardware configuration similar to the terminal device 110.

In the present example embodiment, the terminal devices 210A to 210D may or may not retain the blockchain BC. In addition, the terminal devices 210A to 210D may or may not calculate hash values HA to HE. Furthermore, the terminal devices 210A to 210D may or may not detect falsification.

### <Data Management Device>

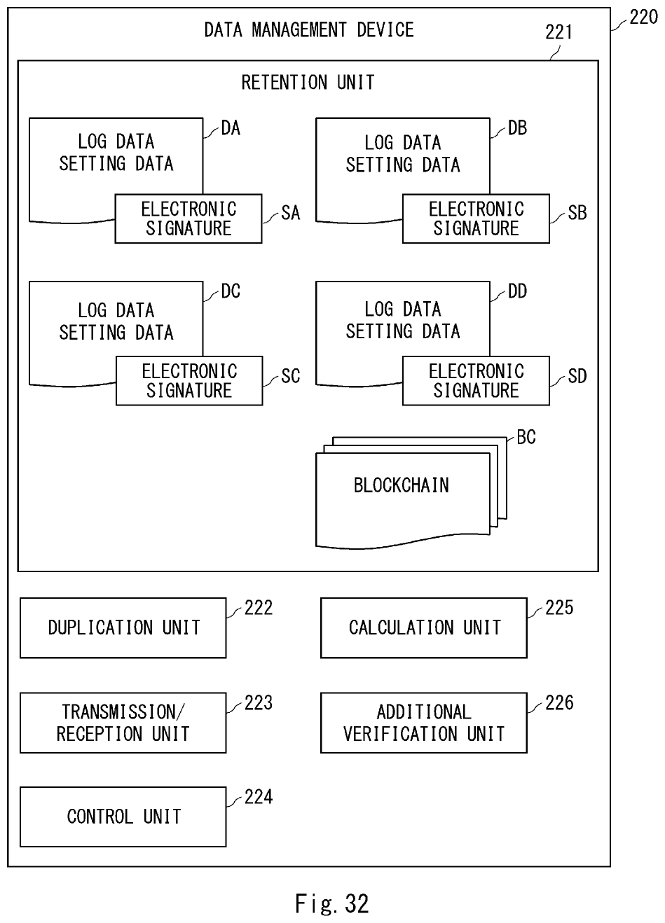

Next, a configuration of the data management device 220 is described. FIG. 32 is a block diagram showing an example of the data management device 220 in the management system 200 according to the second example embodiment.

As shown in FIG. 32, the data management device 220 includes a retention unit 221, a duplication unit 222, a transmission/reception unit 223, and a control unit 224. Similarly to the data management device 120, the retention unit 221, the duplication unit 222, the transmission/reception unit 223, and the control unit 224 have functions as a retention means for retaining electronically-signed data, a duplication means for duplicating electronically-signed data, a transmission/reception means for transmitting and receiving electronically-signed data, and a control means for controlling the data management device 220 (the retention unit 221, the duplication unit 222, and the transmission/reception unit 223), respectively.

The data management device 220 further includes a calculation unit 225 and an additional verification unit 226. The calculation unit 225 and the additional verification unit 226 have functions as a calculation means of a hash value and an additional verification means of a hash value. With this configuration, the transmission/reception unit 223 of the data management device 220 receives, from the terminal devices 210A to 210D, data DA to data DD generated by the terminal devices 210A to 210D. Then, the data management device 220 calculates hash values HA to HD from the received data DA to data DD. The data management device 220 adds the calculated hash values HA to HD to the retained blockchain BC. In this manner, the data management device 220 retains the blockchain BC.

The data management device 220 may have a hardware configuration similar to that of the data management device 120. The data management device 220 may receive, from the terminal devices 210A to 210D, the data DA to data DE generated by the terminal devices 210A to 210D and calculate the hash values HA to HD. In addition, the data management device 220 may receive the hash values HA to HD calculated by the terminal devices 210A to 210D.

The data management device 220 may retain the blockchain BC together with the terminal devices 210A to 210D or only the data management device 220 may retain the blockchain BC.

The data management device 220 may detect falsification of retention data DA to data DD retained by the terminal devices 210A to 210D. In that case, the hash values HA to HD of the retention data DA to data DD retained by the terminal devices 210A to 210D are compared with the hash values HA to HD contained in the blockchain retained by the data management device 220.

When falsification is detected, the data management device 220 disconnects the terminal device 210A that has detected the falsification. Then, the data management device 220 invalidates the retention data of the terminal device 210A. Thereafter, by transmitting electronically-signed data to the disconnected terminal device 210A, the data is restored, and the terminal device 210A is reconnected.

Next, the effects of the present example embodiment are described. The management system 200 according to the present example embodiment is a client-to-server type, and the terminal devices 210A to 210D are connected to the data management device 220. The data management device 220 retains the blockchain BC. Thus, the operations of the management system 200 can be integrally managed. Accordingly, it is possible to integrally performs addition of the new terminal device 210E, the detection of falsification, and the restoration of data.

In addition, the management system 200 according to the present example embodiment transmits and receives data via the data management device 220. Thus, the management system 200 can be adapted to an IoT system that collects data from the terminal devices 210 scattered in multiple locations. Other configurations and effects are included in the description of the example embodiment and first example embodiment described above.

The present invention has been described with reference to the example embodiments, but the present invention is not limited to the above example embodiments. Various changes can be made in the configurations and details of the present invention that can be understood by those skilled in the art within the scope of the present invention. For example, a combination of the configurations in the outline of the example embodiment and the first and second example embodiments is also included in the scope of the present invention. In addition, a program causing a computer to execute the processing methods, data management methods, and management methods in the outline of the example embodiment and the first and second example embodiments is also included in the scope of the present invention.

A part or all of the above example embodiments may be described as the following Supplementary notes but are not limited to the following.

### (Supplementary Note 1)

A terminal device connected, together with other terminal devices, to a network, the terminal device configured:
to retain, together with the other terminal devices, a blockchain formed by linking data generated by each terminal device or a hash value of the data as blocks; and
to add, when a new terminal device is to be added to the network, new data generated by the new terminal device or a hash value of the new data to the blockchain together with the other terminal devices.

### (Supplementary Note 2)

The terminal device according to Supplementary note 1 comprising: a generation/retention means for generating the data and retaining the generated data as retention data;
a calculation means for calculating the hash value of the generated data;
a duplication means for duplicating at least one of the data and the hash value;
a transmission/reception means for transmitting at least one of the duplicated data and the duplicated hash value to the network as transmission data and a transmission hash value and receiving at least one of the data and the hash value from the other terminal devices as reception data and a reception hash value;
a retention means for retaining the blockchain; and
an additional verification means for adding the received reception data or the received reception hash value to the blockchain,
wherein the additional verification means adds, when the new terminal device is to be added to the network, the new data or the hash value of the new data to the blockchain.

### (Supplementary Note 3)

The terminal device according to Supplementary note 2, wherein the additional verification means detects falsification of the retention data by comparing the retention data or a hash value of the retention data with the transmission data or the transmission hash value contained in the blockchain retained by the other terminal devices.

### (Supplementary Note 4)

The terminal device according to Supplementary note 3, further comprising a control means for disconnecting from a server device configured to provide a service on the network when the additional verification means detects the falsification.

### (Supplementary Note 5)

The terminal device according to Supplementary note 4, wherein the control means invalidates the retention data when the falsification is detected.

### (Supplementary Note 6)

The terminal device according to Supplementary note 4 or 5, further comprising:

an electronically-signed-data generation means for generating electronically-signed data by adding an electronic signature formed using a secret key unique to each of the terminal devices to the data generated by the generation/retention means; and
a decryption means for decrypting the electronic signature, wherein
the decryption means receives the electronically-signed data from a data management device configured to retain the electronically-signed data generated by each of the terminal devices and decrypts the electronic signature of the received electronically-signed data,
the calculation means calculates a hash value of the received electronically-signed data,
the additional verification means verifies a match between the received electronically-signed data and the transmission data or between the calculated hash value of the electronically signed data and the transmission hash value contained in the blockchain retained by the other terminal devices, and
the control means is connected to the server device when the additional verification means verifies the match.

### (Supplementary Note 7)

The terminal device according to any one of Supplementary notes 1 to 6 connected to the data management device configured to retain electronically-signed data generated by adding, to the data generated by each of the terminal devices, the electronic signature formed using the secret key unique to each of the terminal devices.

### (Supplementary Note 8)

A data management device connected to a network together with a plurality of terminal devices, each of the terminal devices configured to retain a blockchain formed by linking data generated by each of the terminal devices or a hash value of the data as blocks, the data management device configured:

to retain electronically-signed data generated by adding, to the data generated by each of the terminal devices, the electronic signature formed using the secret key unique to each of the terminal devices; and
to add, when a new terminal device is to be added to the network and when new data generated by the new terminal device or a hash value of the new data is to be added to the blockchain retained by each of the terminal devices, the electronically-signed data generated by the new terminal device to the data management device itself.

### (Supplementary Note 9)

The data management device according to Supplementary note 8 is configured to transmit, when the terminal device that has been disconnected from the network is to be reconnected to the network, the retained electronically-signed data to the connecting terminal device.

### (Supplementary Note 10)

The data management device according to Supplementary note 8 or 9, comprising:
a retention means for retaining the electronically-signed data;
a duplication means for duplicating the electronically-signed data;
a transmission/reception means for transmitting and receiving the electronically-signed data; and
a control means for controlling the retention means, the duplication means, and the transmission/reception means.

### (Supplementary Note 11)

A management system comprising:
a plurality of devices; and
a network connected with the plurality of devices, wherein
at least one of the plurality of devices is configured to retain a blockchain formed by linking data generated by two or more of the plurality of devices or a hash value of the data as blocks, and
the one of the plurality of devices is configured to add, when a new device is to be added to the network, new data generated by the new device or a hash value of the new data to the blockchain.

### (Supplementary Note 12)

The management system according to Supplementary note 11, wherein
the plurality of devices includes a plurality of terminal devices,
each of the terminal devices is configured to retain a blockchain formed by linking data generated by each of the terminal devices or a hash value of the data as blocks, and
each of the terminal devices is configured to add, when a new terminal device is to be added to the network, new data generated by the new terminal device or a hash value of the new data to the blockchain.

### (Supplementary Note 13)

The management system according to Supplementary note 12, wherein
the each terminal device comprises:
   a generation/retention means for generating the data and retaining the generated data as retention data;
   a calculation means for calculating the hash value of the generated data;
   a duplication means for duplicating at least one of the data and the hash value;
   a transmission/reception means for transmitting at least one of the duplicated data and the duplicated hash value to the network as transmission data and a transmission hash value and receiving at least one of the data and the hash value from the other terminal devices as reception data and a reception hash value;
   a retention means for retaining the blockchain; and
   an additional verification means for adding the received reception data or the received reception hash value to the blockchain, and
the additional verification means adds, when the new terminal device is to be added to the network, the new data or the hash value of the new data to the blockchain.

### (Supplementary Note 14)

The management system according to Supplementary note 13, wherein
the plurality of terminal devices includes at least a first terminal device and a second terminal device, and
the first terminal device is configured to detect falsification of the retention data by comparing the retention data with the transmission data or comparing a hash value of the retention data with the transmission hash value transmitted by the first terminal device and contained in the blockchain retained by the second terminal device.

### (Supplementary Note 15)

The management system according to Supplementary note 14, further comprising a server device configured to provide a service, wherein
each of the terminal devices comprises a control means for disconnecting from the server device, and
the control means of the first terminal device disconnects from the server device when the first terminal device detects the falsification.

### (Supplementary Note 16)

The management system according to Supplementary note 15, wherein the control means of the first terminal device invalidates the retention data when the falsification is detected.

### (Supplementary Note 17)

The management system according to Supplementary note 15 or 16, wherein
each of the terminal devices comprises:
   an electronically-signed-data generation means for generating electronically-signed data by adding an electronic signature formed using a secret key unique to each of the terminal devices to the data generated by the generation/retention means; and
   a decryption means for decrypting the electronic signature,
the decryption means of the first terminal device receives the electronically-signed data from a data management device configured to retain the electronically-signed data generated by each of the terminal devices and decrypts the received electronically-signed data,
the calculation means of the first terminal device calculates a hash value of the received electronically-signed data,
the additional verification means of the first terminal device verifies a match between the received electronically-signed data or the calculated hash value and the transmission data or the transmission hash value transmitted by the first terminal device and contained in the blockchain retained by the second terminal device, and
the control means of the first terminal device connects to the server device when the additional verification means verifies the match.

### (Supplementary Note 18)

The management system according to any one of Supplementary notes 12 to 17, further comprising a data management device connected, together with the plurality of terminal devices, to the network and configured to retain electronically-signed data generated by adding, to the data generated by each of the terminal devices, the electronic signature formed using the secret key unique to each of the terminal devices.

### (Supplementary Note 19)

The management system according to Supplementary note 18, wherein the electronically-signed data generated by adding an electronic signature formed using a secret key unique to the new terminal device is added to the data management device when the new terminal device is to be added to the network.

### (Supplementary Note 20)

The management system according to Supplementary note 18 or 19, wherein the data management device is configured to transmit, when the terminal device that has been disconnected from the network is to be reconnected to the network, the retained electronically-signed data to the connecting terminal device.

### (Supplementary Note 21)

The management system according to any one of Supplementary notes 18 to 20, wherein
the data management device comprises:
   a retention means for retaining the electronically-signed data;
   a duplication means for duplicating the electronically-signed data;
   a transmission/reception means for transmitting and receiving the electronically-signed data; and
   a control means for controlling the retention means, the duplication means, and the transmission/reception means.

### (Supplementary Note 22)

The management system according to Supplementary note 11, wherein
the plurality of devices includes a plurality of terminal devices and a data management device connected with the plurality of terminal devices,
the data management device is configured to retain a blockchain formed by linking data generated by each terminal device or a hash value of the data as blocks, and
the data management device is configured to add, when a new terminal device is to be added to the network, new data generated by the new terminal device or a hash value of the new data to the blockchain.

### (Supplementary Note 23)

A processing method comprising:
causing a predetermined terminal device together with other terminal devices to retain a blockchain formed by linking data generated by each of the terminal devices in a network connected together with the other terminal devices or a hash value of the data as blocks; and
causing, when a new terminal device is to be added to the network, the predetermined terminal device to add new data generated by the new terminal device or a hash value of the new data to the blockchain together with the other terminal devices.

### (Supplementary Note 24)

The processing method according to Supplementary note 23, wherein
the causing the predetermined terminal device together with the other terminal devices to retain the blockchain comprises:
   causing the predetermined terminal device to generate the data and to retain the data as retention data;
   causing the predetermined terminal device to calculate the hash value of the generated data;
   causing the predetermined terminal device to duplicate at least one of the data and the hash value;
   causing the predetermined terminal device to transmit at least one of the duplicated data and the duplicated hash value to the network as transmission data and a transmission hash value and to receive at least one of the data and the hash value from the other terminal devices as reception data and a reception hash value; and
   causing the predetermined terminal device to add the received reception data or the received reception hash value to the blockchain.

### (Supplementary Note 25)

The processing method according to Supplementary note 24, comprising causing the predetermined terminal device to detect falsification of the retention data by comparing the retention data or a hash value of the retention data with the transmission data or the transmission hash value contained in the blockchain retained by the other terminal devices.

(Supplementary note 26)

The processing method according to Supplementary note 25, comprising causing, when the falsification is detected, the predetermined terminal device to be disconnected from a server device configured to provide a service on the network.

### (Supplementary Note 27)

The processing method according to Supplementary note 26, comprising causing, when the falsification is detected, the predetermined terminal device to invalidate the retention data.

### (Supplementary Note 28)

The processing method according to Supplementary note 26 or 27, comprising:
causing the predetermined terminal device to generate electronically-signed data in advance by adding, to the generated data, an electronic signature formed using a secret key unique to each of the terminal devices;
after the causing the predetermined terminal device to be disconnected from the server device,
causing the predetermined terminal device to receive the electronically-signed data from a data management device configured to retain the electronically-signed data generated by each of the terminal devices and to decrypt the electronic signature of the received electronically-signed data;
causing the predetermined terminal device to calculate a hash value of the received electronically-signed data;
causing the predetermined terminal device to verify a match between the received electronically-signed data and the transmission data or between the calculated hash value and the transmission hash value contained in the blockchain retained by the other terminal devices; and
causing the predetermined terminal device to be connected to the server device when the match is verified.

### (Supplementary Note 29)

The processing method according to any one of Supplementary notes 23 to 28, comprising causing the predetermined terminal device to be connected to the data management device configured to retain electronically-signed data generated by adding, to the data generated by each of the terminal devices, the electronic signature formed using the secret key unique to each of the terminal devices.

### (Supplementary Note 30)

A data management method comprising:
causing a data management device connected, together with a plurality of terminal devices, to a network, to be connected to each terminal device configured to retain a blockchain formed by linking data generated by each of the terminal devices or a hash value of the data as blocks;
causing the data management device to retain electronically-signed data generated by adding, to the data generated by each of the terminal devices, an electronic signature formed using a secret key unique to each of the terminal devices; and
causing, when a new terminal device is to be added to the network and when new data generated by the new terminal device or a hash value of the new data is to be added to the blockchain retained by each of the terminal devices, the data management device to add the electronically-signed data generated by the new terminal device to the data management device itself.

### (Supplementary Note 31)

The data management method according to Supplementary note 30, comprising causing, when the terminal device that has been disconnected from the network is reconnected to the network, the electronically-signed data retained by the data management device to be transmitted to the connected terminal device.

### (Supplementary Note 32)

The data management method according to Supplementary note 31, wherein
the causing the electronically-signed data retained by the data management device to be transmitted comprises:
   causing the data management device to retain the electronically-signed data;
   causing the data management device to duplicate the electronically-signed data; and
   causing the data management device to transmit and receive the electronically-signed data.

### (Supplementary Note 33)

A management method comprising:
causing at least one of a plurality of devices connected to a network to retain a blockchain formed by linking data generated by two or more of the plurality of devices or a hash value of the data as blocks; and
causing, when a new device is to be added to the network, new data generated by the new device or a hash value of the new data to be added to the blockchain.

### (Supplementary Note 34)

The management method according to Supplementary note 33, wherein
the plurality of devices includes a plurality of terminal devices, and
the management method comprises:
causing each terminal device to retain a blockchain formed by linking data generated by each of the terminal devices in a network connected with each of the terminal devices or a hash value of the data as blocks; and
causing, when a new terminal device is to be added to the network, new data generated by the new terminal device or a hash value of the new data to be added to the blockchain.

### (Supplementary Note 35)

The management method according to Supplementary note 34, wherein
the causing each of the terminal devices to retain the blockchain comprises:
   causing each of the terminal devices to generate the data and to retain the generated data as retention data;
   causing each of the terminal devices to calculate the hash value of the generated data;
   causing each of the terminal devices to duplicate at least one of the data and the hash value;
   causing each of the terminal devices to transmit at least one of the duplicated data and the duplicated hash value to the network as transmission data and a transmission hash value and to receive at least one of the data and the hash value from other terminal devices as reception data and a reception hash value; and
   causing each of the terminal devices to add the received reception data or the received reception hash value to the blockchain.

### (Supplementary Note 36)

The management method according to Supplementary note 35, wherein
the plurality of terminal devices includes at least a first terminal device and a second terminal device, and
the management method comprises causing the first terminal device to detect falsification of the retention data by comparing the retention data or a hash value of the retention data with the transmission data or the transmission hash value transmitted from the first terminal device and contained in the blockchain retained by the second terminal device.

### (Supplementary Note 37)

The management method according to Supplementary note 36, comprising causing, when the falsification is detected, the first terminal device to be disconnected from a server device configured to provide a service on the network.

### (Supplementary Note 38)

The management method according to Supplementary note 37, further comprising causing, when the falsification is detected, the first terminal device to invalidate the retention data.

### (Supplementary Note 39)

The management method according to Supplementary note 37 or 38, comprising:
causing each of the terminal devices to generate electronically-signed data in advance by adding, to the generated data, an electronic signature formed using a secret key unique to each of the terminal devices;
after the causing the first terminal device to be disconnected from the server device,
causing each of the terminal devices to receive the electronically-signed data from a data management device configured to retain the electronically-signed data generated by each of the terminal devices and to decrypt the electronic signature of the received electronically-signed data;
causing each of the terminal devices to calculate a hash value of the received electronically-signed data;
causing each of the terminal devices to verify a match between the received electronically-signed data and the transmission data or between the calculated hash value and the transmission hash value contained in the blockchain retained by the second terminal device; and
causing each of the terminal devices to be connected to the server device when the match is verified.

### (Supplementary Note 40)

The management method according to any one of Supplementary notes 34 to 39, comprising causing a data management device configured to retain electronically-signed data generated by adding, to the data generated by each of the terminal devices, the electronic signature formed using the secret key unique to each of the terminal devices to be connected to.

### (Supplementary Note 41)

The management method according to Supplementary note 40, comprising causing, when the new terminal device is to be added to the network, the electronically-signed data generated by adding an electronic signature formed using a secret key unique to the new terminal device to be added to the data management device.

### (Supplementary Note 42)

The management method according to Supplementary note 40 or 41, comprising a step of causing, when the terminal device that has been disconnected from the network is reconnected to the network, the electronically-signed data retained by the data management device to be transmitted to the connected terminal device.

### (Supplementary Note 43)

The management method according to Supplementary note 42, wherein
the causing the electronically-signed data retained by the data management device to be transmitted comprises:
   causing the data management device to retain the electronically-signed data;
   causing the data management device to duplicate the electronically-signed data; and
   causing the data management device to transmit and receive the electronically-signed data.

### (Supplementary Note 44)

The management method according to Supplementary note 33, wherein
the plurality of devices includes a plurality of terminal devices and a data management device connected with the plurality of terminal devices, and
the management method comprises:
causing the data management device to retain a blockchain formed by linking data generated by each terminal device in a network connected with each of the terminal devices or a hash value of the data as blocks; and
causing, when a new terminal device is to be added to the network, new data generated by the new terminal device or a hash value of the new data to be added to the blockchain.

### (Supplementary Note 45)

A non-transitory computer-readable medium storing a program causing a computer to execute:
causing a predetermined terminal device together with other terminal devices to retain a blockchain formed by linking data generated by each terminal device in a network connected together with the other terminal devices or a hash value of the data as blocks; and
causing, when a new terminal device is to be added to the network, the predetermined terminal device to add new data generated by the new terminal device or a hash value of the new data to the blockchain together with the other terminal devices.

### (Supplementary Note 46)

The non-transitory computer-readable medium storing the program according to Supplementary note 45, wherein
the causing the predetermined terminal device together with the other terminal devices to retain the blockchain comprises:
   causing the predetermined terminal device to generate the data and to retain the data as retention data;
   causing the predetermined terminal device to calculate the hash value of the generated data;
   causing the predetermined terminal device to duplicate at least one of the data and the hash value;
   causing the predetermined terminal device to transmit at least one of the duplicated data and the duplicated hash value to the network as transmission data and a transmission hash value and to receive at least one of the data and the hash value from the other terminal devices as reception data and a reception hash value; and
   causing the predetermined terminal device to add the received reception data or the received reception hash value to the blockchain.

### (Supplementary Note 47)

The non-transitory computer-readable medium storing the program according to Supplementary note 46, the program causing the computer to execute causing the predetermined terminal device to detect falsification of the retention data by comparing the retention data or a hash value of the retention data with the transmission data or the transmission hash value contained in the blockchain retained by the other terminal devices.

### (Supplementary Note 48)

The non-transitory computer-readable medium storing the program according to Supplementary note 47, the program causing the computer to execute causing, when the falsification is detected, the predetermined terminal device to disconnect from a server device configured to provide a service on the network.

### (Supplementary Note 49)

The non-transitory computer-readable medium storing the program according to Supplementary note 48, the program causing the computer to execute causing, when the falsification is detected, the predetermined terminal device to invalidate the retention data.

### (Supplementary Note 50)

The non-transitory computer-readable medium storing the program according to Supplementary note 48 or 49, the program causing the computer to execute:
causing the predetermined terminal device to generate electronically-signed data in advance by adding, to the generated data, an electronic signature formed using a secret key unique to each of the terminal devices;
after the causing the predetermined terminal device to disconnect from the server device,
causing the predetermined terminal device to receive the electronically-signed data from a data management device configured to retain the electronically-signed data generated by each of the terminal devices and to decrypt the electronic signature of the received electronically-signed data;
causing the predetermined terminal device to calculate a hash value of the received electronically-signed data;
causing the predetermined terminal device to verify a match between the received electronically-signed data or the calculated hash value and the transmission data or the transmission hash value contained in the blockchain retained by the other terminal devices; and
causing the predetermined terminal device to connect to the server device when the match is verified.

### (Supplementary Note 51)

The non-transitory computer-readable medium storing the program according to any one of Supplementary notes 45 to 50, the program causing the computer to execute causing the predetermined terminal device to connect to the data management device configured to retain electronically-signed data generated by adding, to the data generated by each of the terminal devices, the electronic signature formed using the secret key unique to each of the terminal devices.

### (Supplementary Note 52)

A non-transitory computer-readable medium storing a program causing a computer to execute:
causing a data management device connected to a network together with a plurality of terminal devices to connect to each terminal device configured to retain a blockchain formed by linking data generated by each of the terminal devices or a hash value of the data as blocks;
causing the data management device to retain electronically-signed data generated by adding, to the data generated by each of the terminal devices, an electronic signature formed using a secret key unique to each of the terminal devices; and
causing, when a new terminal device is to be added to the network and when new data generated by the new terminal device or a hash value of the new data is to be added to the blockchain retained by each of the terminal devices, the data management device to add the electronically-signed data generated by the new terminal device to the data management device itself.

### (Supplementary Note 53)

The non-transitory computer-readable medium storing the program according to Supplementary note 52, the program causing the computer to execute causing, when the terminal device that has been disconnected from the network is reconnected to the network, the electronically-signed data retained by the data management device to be transmitted to the connected terminal device.

### (Supplementary Note 54)

The non-transitory computer-readable medium storing the program according to Supplementary note 53, wherein
the causing the electronically-signed data retained by the data management device to be transmitted comprises:
   causing the data management device to retain the electronically-signed data;
   causing the data management device to duplicate the electronically-signed data; and
   causing the data management device to transmit and receive the electronically-signed data.

### (Supplementary Note 55)

A non-transitory computer-readable medium storing a program causing a computer to execute:
causing at least one of a plurality of devices connected to a network to retain a blockchain formed by linking data generated by two or more of the plurality of devices or a hash value of the data as blocks; and
causing, when a new device is to be added to the network, new data generated by the new device or a hash value of the new data to be added to the blockchain.

### (Supplementary Note 56)

The non-transitory computer-readable medium storing the program according to Supplementary note 55, wherein
the plurality of devices includes a plurality of terminal devices, and
the program causes the computer to execute:
causing each of the terminal devices to retain a blockchain formed by linking data generated by each of the terminal devices in a network connected with each of the terminal devices or a hash value of the data as blocks; and
causing, when a new terminal device is to be added to the network, new data generated by the new terminal device or a hash value of the new data to be added to the blockchain.

### (Supplementary Note 57)

The non-transitory computer-readable medium storing the program according to Supplementary note 56, wherein
the causing each of the terminal devices to retain the blockchain comprises:
   causing each of the terminal devices to generate the data and to retain the generated data as retention data;
   causing each of the terminal devices to calculate the hash value of the generated data;
   causing each of the terminal devices to duplicate at least one of the data and the hash value;
   causing each of the terminal devices to transmit at least one of the duplicated data and the duplicated hash value to the network as transmission data and a transmission hash value and to receive at least one of the data and the hash value from other terminal devices as reception data and a reception hash value; and
   causing each of the terminal devices to add the received reception data or the received reception hash value to the blockchain.

### (Supplementary Note 58)

The non-transitory computer-readable medium storing the program according to Supplementary note 57, wherein
the plurality of terminal devices includes at least a first terminal device and a second terminal device, and
the program causes the computer to execute causing the first terminal device to detect falsification of the retention data by comparing the retention data or a hash value of the retention data with the transmission data or the transmission hash value transmitted from the first terminal device and contained in the blockchain retained by the second terminal device.

### (Supplementary Note 59)

The non-transitory computer-readable medium storing the program according to Supplementary note 58, the program causing the computer to execute causing, when the falsification is detected, the first terminal device to disconnect from a server device configured to provide a service on the network.

### (Supplementary Note 60)

The non-transitory computer-readable medium storing the program according to Supplementary note 59, the program causing the computer to execute causing, when the falsification is detected, the first terminal device to invalidate the retention data.

### (Supplementary Note 61)

The non-transitory computer-readable medium storing the program according to Supplementary note 59 or 60, the program causing the computer to execute:
causing each of the terminal devices to generate electronically-signed data in advance by adding, to the generated data, an electronic signature formed using a secret key unique to each of the terminal devices;
after the causing the first terminal device to disconnect from the server device,
causing each of the terminal devices to receive the electronically-signed data from a data management device configured to retain the electronically-signed data generated by each of the terminal devices and to decrypt the electronic signature of the received electronically-signed data;
causing each of the terminal devices to calculate a hash value of the received electronically-signed data;
causing each of the terminal devices to verify a match between the received electronically-signed data or the calculated hash value and the transmission data or the transmission hash value contained in the blockchain retained by the second terminal device; and
causing each of the terminal devices to connect to the server device when the match is verified.

### (Supplementary Note 62)

The non-transitory computer-readable medium storing the program according to any one of Supplementary notes 58 to 61, the program causing the computer to execute causing the data management device configured to retain electronically-signed data generated by adding, to the data generated by each of the terminal devices, the electronic signature formed using the secret key unique to each of the terminal devices to be connected.

### (Supplementary Note 63)

The non-transitory computer-readable medium storing the program according to Supplementary note 62, the program causing the computer to execute causing, when the new terminal device is to be added to the network, the electronically-signed data generated by adding an electronic signature formed using a secret key unique to the new terminal device to be added to the data management device.

### (Supplementary Note 64)

The non-transitory computer-readable medium storing the program according to Supplementary note 62 or 63, the program causing the computer to execute causing, when the terminal device that has been disconnected from the network is reconnected to the network, the electronically-signed data retained by the data management device to be transmitted to the connected terminal device.

### (Supplementary Note 65)

The non-transitory computer-readable medium storing the program according to Supplementary note 64, wherein
the causing the electronically-signed data retained by the data management device to be transmitted comprises:
   causing the data management device to retain the electronically-signed data;
   causing the data management device to duplicate the electronically-signed data; and
   causing the data management device to transmit and receive the electronically-signed data.

### (Supplementary Note 66)

The non-transitory computer-readable medium storing the program according to Supplementary note 65, wherein
the plurality of devices includes a plurality of terminal devices and a data management device connected with the plurality of terminal devices, and
the program causes the computer to execute:
causing the data management device to retain a blockchain formed by linking data generated by each terminal device in a network connected with each of the terminal devices or a hash value of the data as blocks; and
causing, when a new terminal device is to be added to the network, new data generated by the new terminal device or a hash value of the new data to be added to the blockchain.

### REFERENCE SIGNS LIST

1, 100, 200 Management system
10, 10A, 10B, 10C, 10D, 10E Terminal device
11, 111, 211 Generation/retention unit
12, 112, 212 Calculation unit
13, 113, 213 Duplication unit
14, 114, 214 Transmission/reception unit
15, 115, 215 Retention unit
16, 116, 216 Additional verification unit
17, 117, 217 Control unit
110, 110A, 110B, 110C, 110D, 110E Terminal device
118, 218 Electronic signature unit
119, 219 Decryption unit
120, 220 Data management device
121, 221 Retention unit
122, 222 Duplication unit
123, 223 Transmission/reception unit
124, 224 Control unit
130 Server device
210, 210A, 210B, 210C, 210D, 210E Terminal device
225 Calculation unit
226 Additional verification unit
BC Blockchain
BRA, BRB, BRC, BRD Block
DA, DB, DC, DD, DE Data
HA, HB, HC, HD, HE Hash value
NW Network
SA, SB, SC, SD, SE Electronic signature

What is claimed is:

1. A terminal device connected, together with other terminal devices, to a network, the terminal device configured:
to retain, together with the other terminal devices, a blockchain formed by linking data generated by each terminal device or a hash value of the data as blocks; and
to add, when a new terminal device is to be added to the network, new data generated by the new terminal device or a hash value of the new data to the blockchain together with the other terminal devices.

2. The terminal device according to claim 1 comprising:
a generation/retention unit configured to generate the data and to retain the generated data as retention data;
a calculation unit configured to calculate the hash value of the generated data;
a duplication unit configured to duplicate at least one of the data and the hash value;
a transmission/reception unit configured to transmit at least one of the duplicated data and the duplicated hash value to the network as transmission data and a transmission hash value and to receive at least one of the data and the hash value from the other terminal devices as reception data and a reception hash value;
a retention unit configured to retain the blockchain; and
an additional verification unit configured to add the received reception data or the received reception hash value to the blockchain,
wherein the additional verification unit adds, when the new terminal device is to be added to the network, the new data or the hash value of the new data to the blockchain.

3. The terminal device according to claim 2, wherein the additional verification unit detects falsification of the retention data by comparing the retention data or a hash value of the retention data with the transmission data or the transmission hash value contained in the blockchain retained by the other terminal devices.

4. The terminal device according to claim 3, further comprising a control unit configured to disconnect the terminal device from a server device configured to provide a service on the network when the additional verification unit detects the falsification.

5. The terminal device according to claim 4, wherein the control unit invalidates the retention data when the falsification is detected.

6. The terminal device according to claim 4, further comprising:
an electronically-signed-data generation unit configured to generate electronically-signed data by adding an electronic signature formed using a secret key unique to each of the terminal devices to the data generated by the generation/retention unit; and
a decryption unit configured to decrypt the electronic signature, wherein
the decryption unit receives the electronically-signed data from a data management device configured to retain the electronically-signed data generated by each of the terminal devices and decrypts the electronic signature of the received electronically-signed data,
the calculation unit calculates a hash value of the received electronically-signed data,
the additional verification unit verifies a match between the received electronically-signed data and the transmission data or between the calculated hash value of the electronically signed data and the transmission hash value contained in the blockchain retained by the other terminal devices, and
the control unit is connected to the server device when the additional verification unit verifies the match.

7. The terminal device according to claim 6 connected to the data management device configured to retain electronically-signed data generated by adding, to the data generated by each of the terminal devices, the electronic signature formed using the secret key unique to each of the terminal devices.

8. A data management device connected to a network together with a plurality of terminal devices, each of the terminal devices configured to retain a blockchain formed by linking data generated by each of the terminal devices or a hash value of the data as blocks, the data management device configured:
to retain electronically-signed data generated by adding, to the data generated by each of the terminal devices, the electronic signature formed using the secret key unique to each of the terminal devices; and
to add, when a new terminal device is to be added to the network and when new data generated by the new terminal device or a hash value of the new data is to be added to the blockchain retained by each of the terminal devices, the electronically-signed data generated by the new terminal device to the data management device itself.

9. The data management device according to claim 8 is configured to transmit, when the terminal device that has been disconnected from the network is to be reconnected to the network, the retained electronically-signed data to the connecting terminal device.

10. The data management device according to claim 8, comprising:
a retention unit configured to retain the electronically-signed data;
a duplication unit configured to duplicate the electronically-signed data;
a transmission/reception unit configured to transmit and to receive the electronically-signed data; and
a control unit configured to control the retention unit, the duplication unit, and the transmission/reception unit.

11. A management system comprising:
a plurality of devices; and
a network connected with the plurality of devices, wherein
at least one of the plurality of devices is configured to retain a blockchain formed by linking data generated by two or more of the plurality of devices or a hash value of the data as blocks, and
the one of the plurality of devices is configured to add, when a new device is to be added to the network, new data generated by the new device or a hash value of the new data to the blockchain.

12. The management system according to claim 11, wherein
the plurality of devices includes a plurality of terminal devices,
each of the terminal devices is configured to retain a blockchain formed by linking data generated by each of the terminal devices or a hash value of the data as blocks, and
each of the terminal devices is configured to add, when a new terminal device is to be added to the network, new data generated by the new terminal device or a hash value of the new data to the blockchain.

13. The management system according to claim 12, wherein
the each terminal device comprises:
a generation/retention unit configured to generate the data and to retain the generated data as retention data;
a calculation unit configured to calculate the hash value of the generated data;
a duplication unit configured to duplicate at least one of the data and the hash value;
a transmission/reception unit configured to transmit at least one of the duplicated data and the duplicated hash value to the network as transmission data and a transmission hash value and to receive at least one of the data and the hash value from the other terminal devices as reception data and a reception hash value;
a retention unit configured to retain the blockchain; and
an additional verification unit configured to add the received reception data or the received reception hash value to the blockchain, and
the additional verification unit adds, when the new terminal device is to be added to the network, the new data or the hash value of the new data to the blockchain.

14. The management system according to claim 13, wherein
the plurality of terminal devices includes at least a first terminal device and a second terminal device, and
the first terminal device is configured to detect falsification of the retention data by comparing the retention data with the transmission data or comparing a hash value of the retention data with the transmission hash value transmitted by the first terminal device and contained in the blockchain retained by the second terminal device.

15. The management system according to claim 14, further comprising a server device configured to provide a service, wherein
each of the terminal devices comprises a control unit configured to disconnect from the server device, and
the control unit of the first terminal device disconnects the first terminal device from the server device when the first terminal device detects the falsification.

16. The management system according to claim 15, wherein the control unit of the first terminal device invalidates the retention data when the falsification is detected.

17. The management system according to claim 15, wherein
each of the terminal devices comprises:
an electronically-signed-data generation unit configured to generate electronically-signed data by adding an electronic signature formed using a secret key unique to each of the terminal devices to the data generated by the generation/retention unit; and
a decryption unit configured to decrypt the electronic signature,
the decryption unit of the first terminal device receives the electronically-signed data from a data management device configured to retain the electronically-signed data generated by each of the terminal devices and decrypts the received electronically-signed data,
the calculation unit of the first terminal device calculates a hash value of the received electronically-signed data,
the additional verification unit of the first terminal device verifies a match between the received electronically-signed data or the calculated hash value and the transmission data or the transmission hash value transmitted by the first terminal device and contained in the blockchain retained by the second terminal device, and
the control unit of the first terminal device connects to the server device when the additional verification unit verifies the match.

18. The management system according to claim 12, further comprising a data management device connected, together with the plurality of terminal devices, to the network and configured to retain electronically-signed data generated by adding, to the data generated by each of the terminal devices, the electronic signature formed using the secret key unique to each of the terminal devices.

19. The management system according to claim 18, wherein the electronically-signed data generated by adding an electronic signature formed using a secret key unique to the new terminal device is added to the data management device when the new terminal device is to be added to the network.

20. The management system according to claim 18, wherein the data management device is configured to transmit, when the terminal device that has been disconnected from the network is to be reconnected to the network, the retained electronically-signed data to the connecting terminal device.

21. The management system according to claim 18, wherein
the data management device comprises:
a retention unit configured to retain the electronically-signed data;
a duplication unit configured to duplicate the electronically-signed data;
a transmission/reception unit configured to transmit and to receive the electronically-signed data; and
a control unit configured to control the retention unit, the duplication unit, and the transmission/reception unit.

22. The management system according to claim 11, wherein
the plurality of devices includes a plurality of terminal devices and a data management device connected with the plurality of terminal devices,
the data management device is configured to retain a blockchain formed by linking data generated by each terminal device or a hash value of the data as blocks, and
the data management device is configured to add, when a new terminal device is to be added to the network, new data generated by the new terminal device or a hash value of the new data to the blockchain.

23. A processing method comprising:
causing a predetermined terminal device together with other terminal devices to retain a blockchain formed by linking data generated by each of the terminal devices in a network connected together with the other terminal devices or a hash value of the data as blocks; and
causing, when a new terminal device is to be added to the network, the predetermined terminal device to add new data generated by the new terminal device or a hash value of the new data to the blockchain together with the other terminal devices.

24. The processing method according to claim 23, wherein
the causing the predetermined terminal device together with the other terminal devices to retain the blockchain comprises:
causing the predetermined terminal device to generate the data and to retain the data as retention data;
causing the predetermined terminal device to calculate the hash value of the generated data;
causing the predetermined terminal device to duplicate at least one of the data and the hash value;
causing the predetermined terminal device to transmit at least one of the duplicated data and the duplicated hash value to the network as transmission data and a transmission hash value and to receive at least one of the data and the hash value from the other terminal devices as reception data and a reception hash value; and
causing the predetermined terminal device to add the received reception data or the received reception hash value to the blockchain.

25. The processing method according to claim 24, comprising causing the predetermined terminal device to detect falsification of the retention data by comparing the retention data or a hash value of the retention data with the transmission data or the transmission hash value contained in the blockchain retained by the other terminal devices.

26. The processing method according to claim 25, comprising causing, when the falsification is detected, the predetermined terminal device to be disconnected from a server device configured to provide a service on the network.

27. The processing method according to claim 26, comprising causing, when the falsification is detected, the predetermined terminal device to invalidate the retention data.

28. The processing method according to claim 26, comprising:
causing the predetermined terminal device to generate electronically-signed data in advance by adding, to the generated data, an electronic signature formed using a secret key unique to each of the terminal devices;
after the causing the predetermined terminal device to be disconnected from the server device,
causing the predetermined terminal device to receive the electronically-signed data from a data management device configured to retain the electronically-signed data generated by each of the terminal devices and to decrypt the electronic signature of the received electronically-signed data;
causing the predetermined terminal device to calculate a hash value of the received electronically-signed data;
causing the predetermined terminal device to verify a match between the received electronically-signed data and the transmission data or between the calculated hash value and the transmission hash value contained in the blockchain retained by the other terminal devices; and
causing the predetermined terminal device to be connected to the server device when the match is verified.

29. The processing method according to claim 23, comprising causing the predetermined terminal device to be connected to the data management device configured to retain electronically-signed data generated by adding, to the data generated by each of the terminal devices, the electronic signature formed using the secret key unique to each of the terminal devices.

30.-44. (canceled)

45. A non-transitory computer-readable medium storing a program causing a computer to execute:
causing a predetermined terminal device together with other terminal devices to retain a blockchain formed by linking data generated by each terminal device in a network connected together with the other terminal devices or a hash value of the data as blocks; and
causing, when a new terminal device is to be added to the network, the predetermined terminal device to add new data generated by the new terminal device or a hash value of the new data to the blockchain together with the other terminal devices.

46.-66. (canceled)
